(19) United States
(12) Patent Application Publication
(10) Pub. No.: US 2025/0068032 A1
(43) Pub. Date: Feb. 27, 2025

(54) ALL-OPTICAL NON-LINEAR ACTIVATION DEVICE, SYSTEM AND METHOD

(71) Applicant: B. G. NEGEV TECHNOLOGIES AND APPLICATIONS LTD., AT BEN-GURION UNIVERSITY, Beer Sheva (IL)

(72) Inventors: Alina KARABCHEVSKY, Be'er Sheva (IL); Adir HAZAN, Be'er Sheva (IL)

(21) Appl. No.: 18/293,516

(22) PCT Filed: Aug. 1, 2022
(86) PCT No.: PCT/IB2022/057122

§ 371 Date: Jan. 30, 2024

Related U.S. Application Data
(60) Provisional application No. 63/228,110, filed on Aug. 1, 2021.

(51) Int. Cl. G02F 1/365; G06N 3/048; G06N 3/067

(52) U.S. Cl. CPC G02F 1/365; G06N 3/048; G06N 3/067

(57) ABSTRACT

Aspects of embodiments pertain to an optical mapping device having non-linear optical characteristics. The device may comprise an optical unit that is configured to direct an optical signal from an input interface to an output interface of the optical unit. The device includes a substance causing the optical unit to attain saturable absorber characteristics such that absorption of an optical input signal guided from the input interface to the output interface by the optical unit decreases with an increase in optical signal intensity received by the optical unit. In some examples, the saturable absorber characteristics of the mapping device are selectively adaptable.

### CLAIM OF PRIORITY

The present application claims priority to U.S. Provisional Patent Application 63/228,110, filed Aug. 1, 2021, titled “All-Optical Nonlinear Activation Function for Photonic Neural Network” and which is incorporated herein by reference in its entirety.

### BACKGROUND

The properties of activation functions of an Artificial Neural Network are crucial to the ANN's efficiency. Only nonlinear activation functions allow neural networks to compute nontrivial problems using only a small number of nodes. The most important feature of an activation function is its ability to add non-linearity into a neural network, especially for problems with very high patterns such as that faced in computer vision or natural language processing (Goodfellow, I., Bengio, Y., and Courville, A. (2016) Deep learning, MIT press)

The description above is presented as a general overview of related art in this field and should not be construed as an admission that any of the information it contains constitutes prior art against the present patent application.

### BRIEF DESCRIPTION OF THE FIGURES

The figures illustrate generally, by way of example, but not by way of limitation, various embodiments discussed in the present document.

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear. The figures are listed below.

FIG. 1A is a schematic illustration of an all-optically implemented (e.g., MXene-based) artificial neural network (ANN) building block, according to some embodiments.

FIG. 1B is a schematic illustration of the architecture of an ANN (e.g., fully connected Deep NN), according to some embodiments.

FIG. 2A is a schematic illustration of a method for applying a substance having saturable absorption characteristics to overlay a waveguide, according to some embodiments.

FIG. 2B is a schematic illustration of a method for synthesizing MXene, according to some embodiments.

FIG. 3A is a schematic illustration of an experimental inline transmission setup, according to some embodiments.

FIG. 3B shows transmission spectra graphs collected via multimode fibre from the distal end of the waveguides with strip width of 4 μm covered by an MXene flake-based metasurface.

FIG. 3C schematically shows a scanning electron micrograph of the top view on reference waveguides.

FIG. 3D schematically shows a scanning electron micrograph of the top view on waveguides covered by an MXene flake-based metasurface overlayer, according to some embodiments.

FIG. 3E schematically shows calculated field distribution of optical mode propagating in the waveguide core and interacting with MXene nanodiscs indicated by arrows in subplot d with the dispersion of MXene, according to some embodiments.

FIG. 4A schematically shows an experimental thin film or free-space transmission setup used for MXene thin film characterization, according to some embodiments.

FIG. 4B shows graphs of measured transmission spectra of MXene thin-film response to input powers, according to some embodiments.

FIG. 4C shows calculated linear optical transmittance of the Ti₃C₂Tₓ films on a glass substrate, according to some embodiments.

FIG. 4D (top) shows a graph of the saturation intensity vs MXene thickness at the wavelength of 1550 nm.

FIG. 4D (bottom) shows the measured thickness of 50 nm spray-coated MXene with profilometer (average is shown by straight black line) compared to the modelled random roughness of MXene thin film on BK-7 substrate of the depth of 12.7 nm.

FIG. 4E shows a graph of the nonlinear transmission of the 50 nm MXene thin film as a function of input intensity evaluated from the transmission waveguide spectroscopy at the wavelength of 1550 nm.

FIG. 5A (top) schematically shows an emulated three-layer structure of a fully connected network, according to some embodiments.

FIG. 5A (bottom) schematically shows several predicted labels ([9], [3], [0], [7]) and the corresponding input handwritten digit images, according to some embodiments.

FIG. 5B shows graphs that represent a power-in to power-out relation for various operating wavelengths and different setups, according to some embodiments.

FIG. 5C shows network prediction accuracy as a function of epoch count, when the network is trained for 50 epochs, with proposed all-optical nonlinear activation functions considering MXene metasurface overlayer on waveguide and MXene thin film compared to standard software-based nonlinear activation functions

FIG. 5D schematically depicts a diagram of the investigated convolutional neural network illustrating the unique layers and their all-optically implemented nonlinear activation function operations, according to some embodiments.

FIG. 5E show graphs of the accuracy and loss as a function of epoch during the training stage and validation process, for the proposed all-optical MXene-based and the software-based nonlinear activation functions, according to some embodiments.

FIG. 5F show the experimental confusion matrix of a (Modified National Institute of Standards and Technology (MNIST)-database based classification for the chosen 100 images from the test data set, using the transfer function MXene metasurface overlayer and on waveguide at wavelengths of 1550 nm, according to some embodiments.

FIG. S1A-B schematically illustrate the dispersion of MXene thin films, where FIG. S1A shows a graph of the complex permittivity \tilde{ε}(λ), with real ε₁; and FIG. S1B schematically shows imaginary ε₂ parts as a function of the wavelength for different film thicknesses, as follows: 50 nm (solid purple curve), 67 nm (yellow dash-dotted curve), 72 nm (orange dashed curve), and 91 nm (blue dotted curve).

FIG. S2A-B schematically illustrates nanodisks arrangement, where FIG. S2A schematically shows a unit cell 20000 including two nanodisks 20100 and 20200 embedded in water 21000 (light blue medium) located on top of silicon 22000 (grey medium) surface as simulated in the numerical model. Considering the light propagating along with the waveguide core (z-direction), with evanescent field components in the y-direction extending into the sample medium, and where FIG. S2B schematically illustrates the MXene nanodiscs (red) separated by 15 nm along with Perfectly matched layers (PML).

FIG. S3A-B pertain to the embodiment of MXene on a substrate, where FIG. S3A illustrates graphs of computed results of extinction cross-section spectra of MXene nanodiscs atop the waveguide for different input powers, and where FIG. S3B schematically illustrates normalized power loss density in a slice through the MXene nanodisks (the silicon-water interface) at lower (1020 nm) (left image) and longer (1560 nm) wavelengths resonances (right image).

FIG. S4 schematically shows graphs of different common software-based nonlinear activation functions. Represented by input/output relation: ReLU (purple), ELU (orange), tanh (blue), and Swish (yellow).

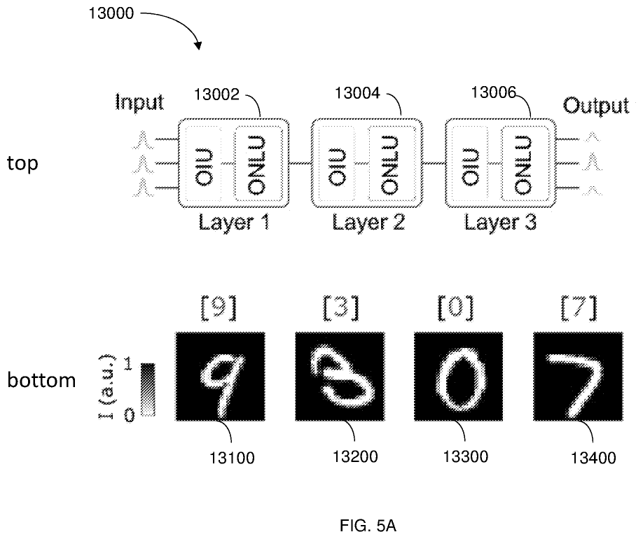

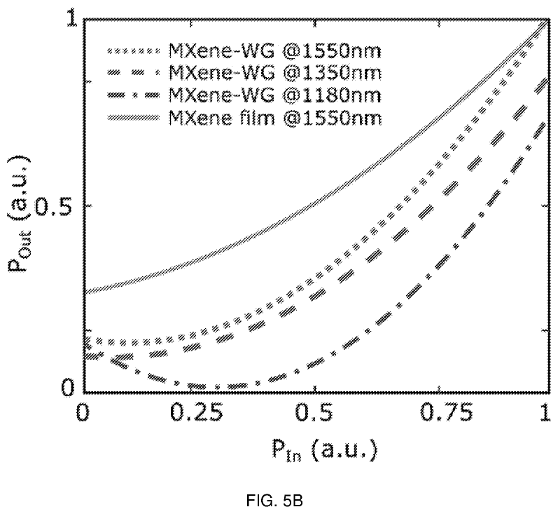

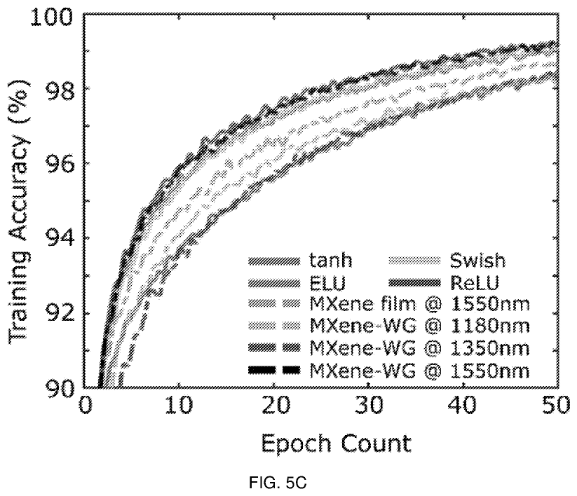

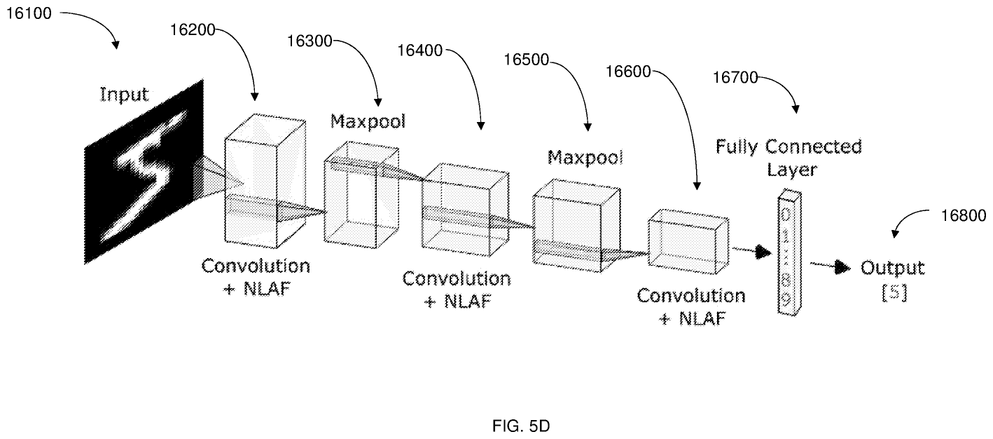

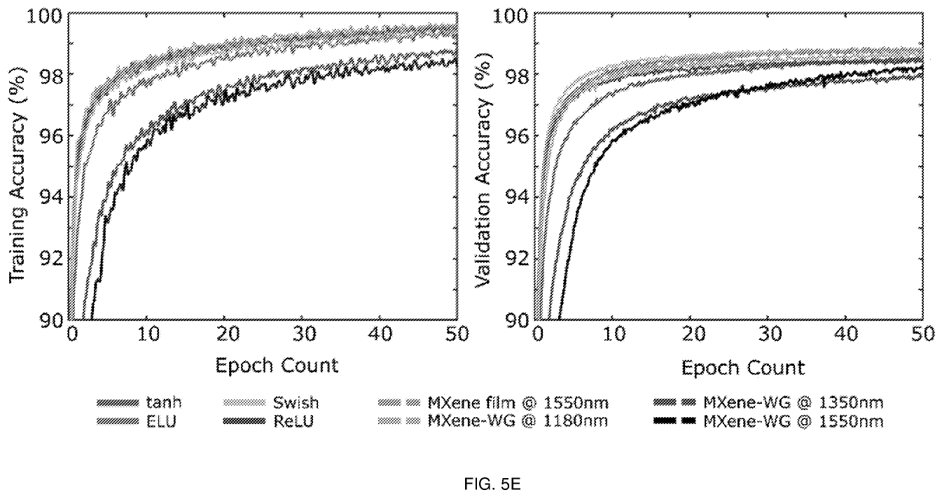

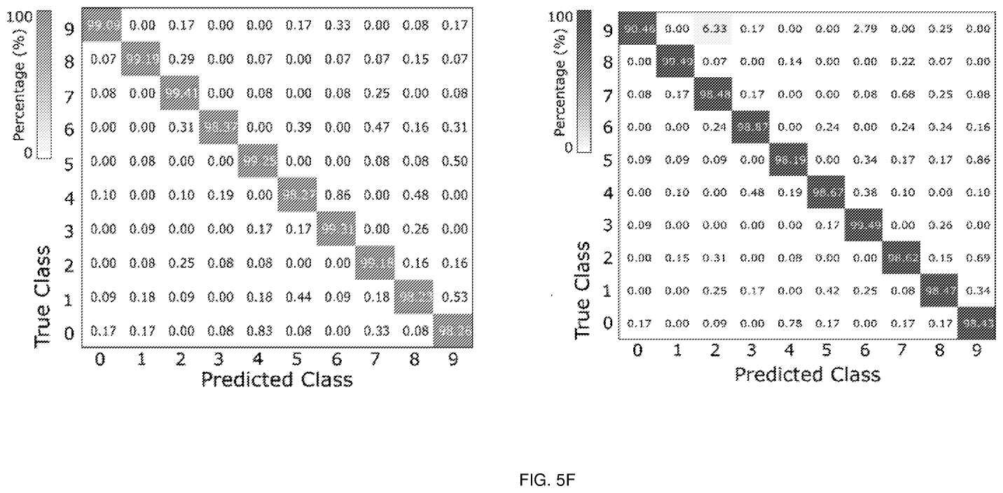

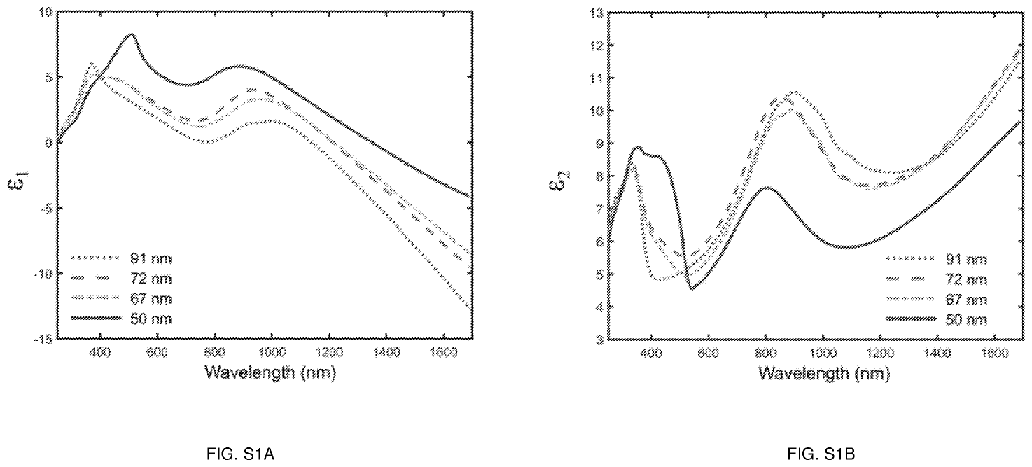

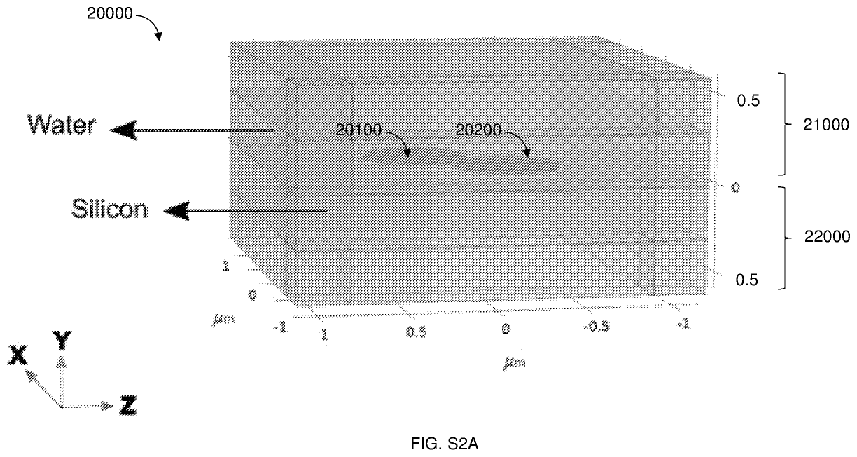

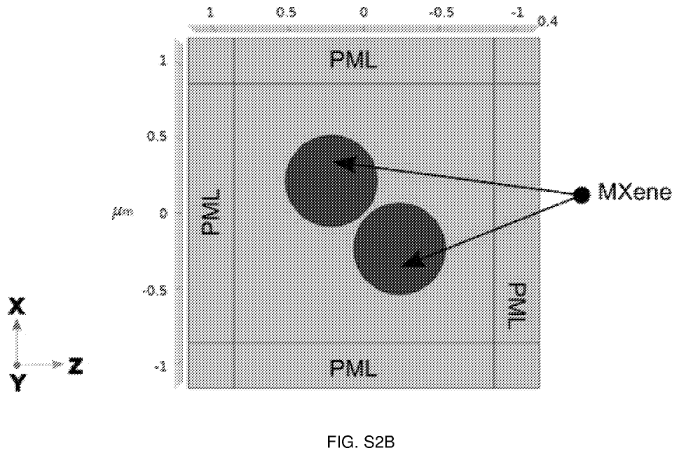

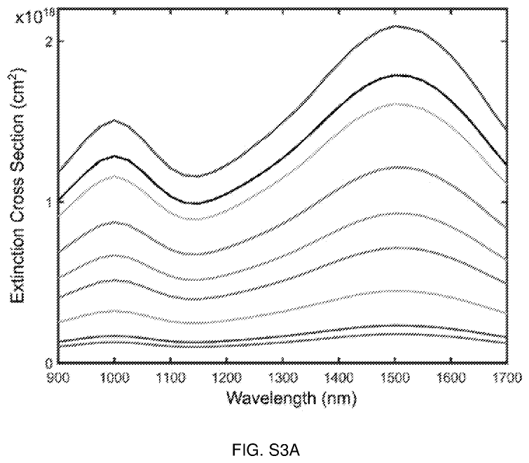

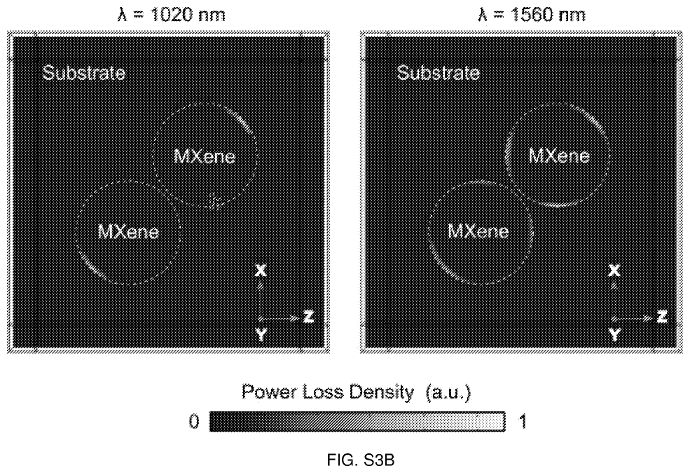

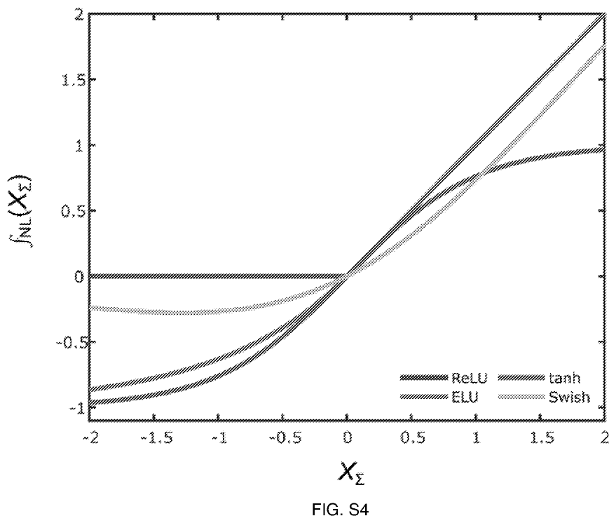

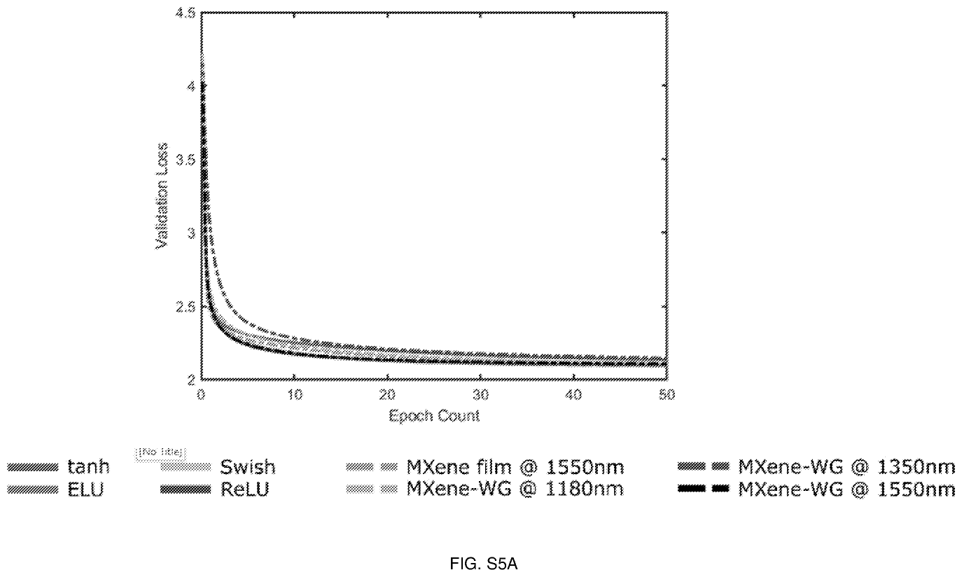

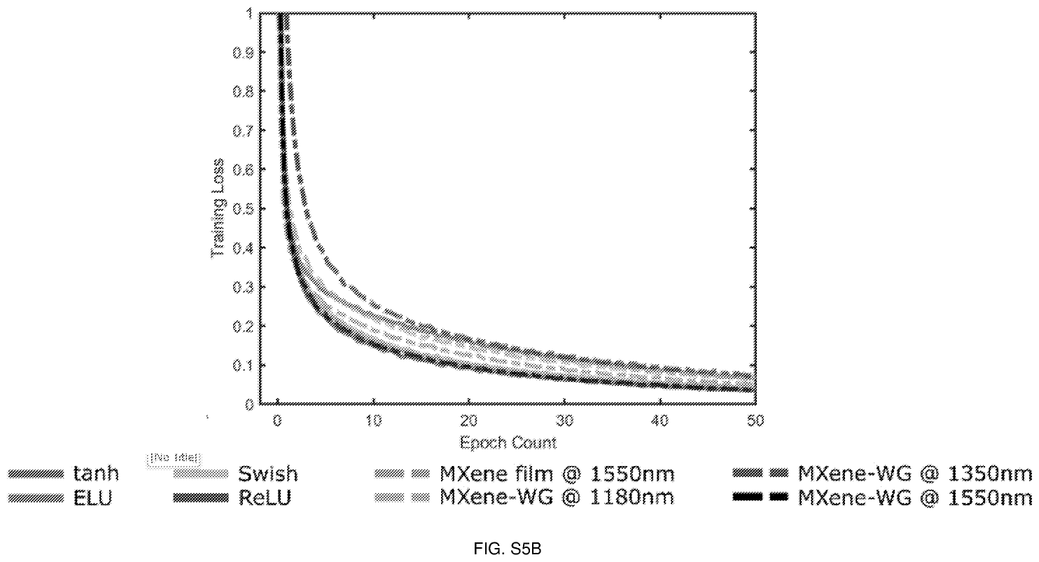

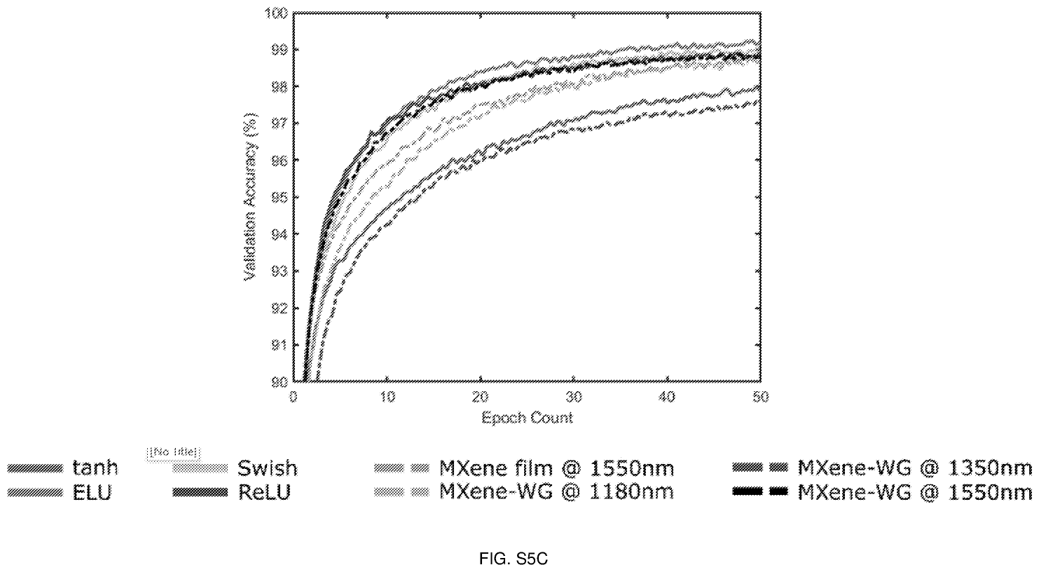

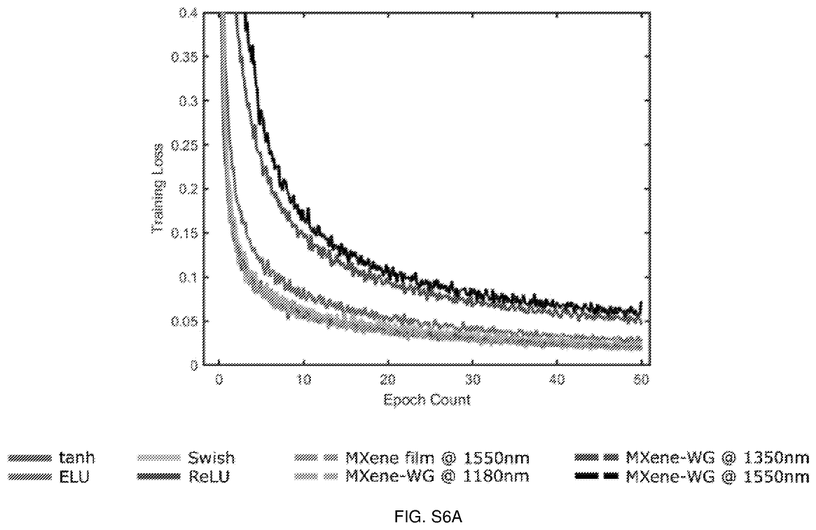

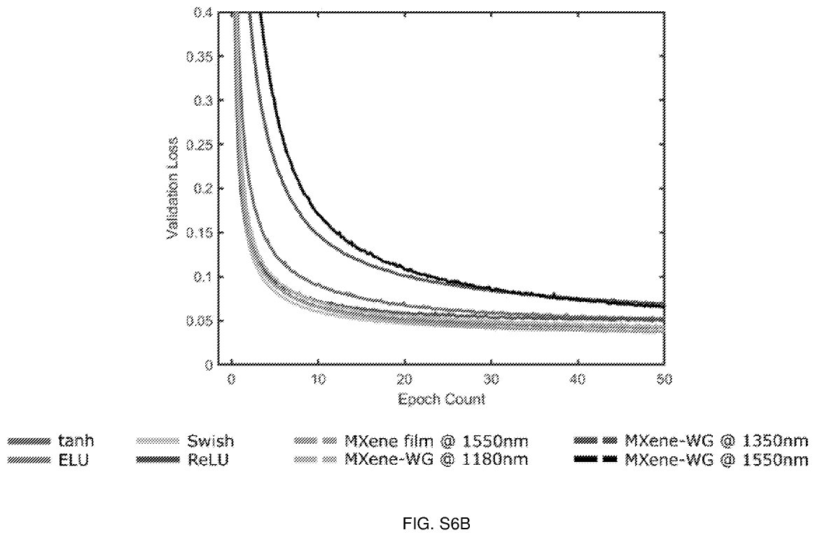

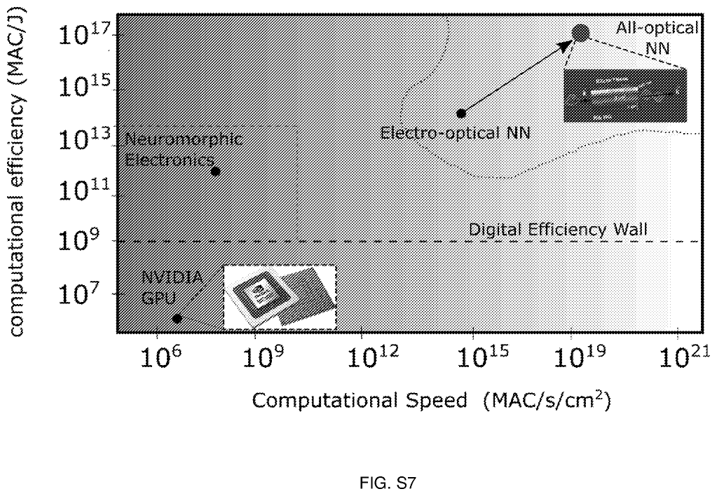

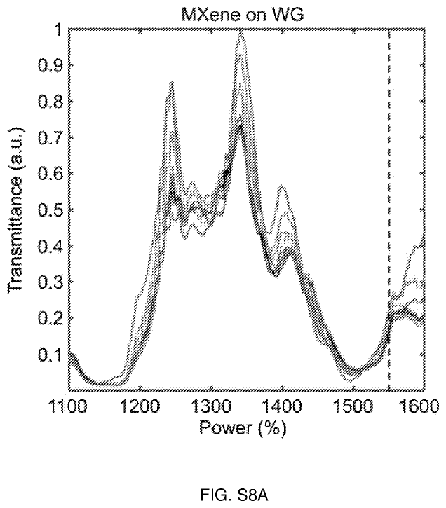

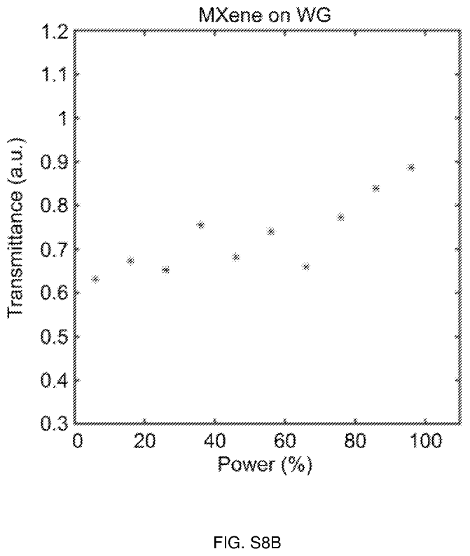

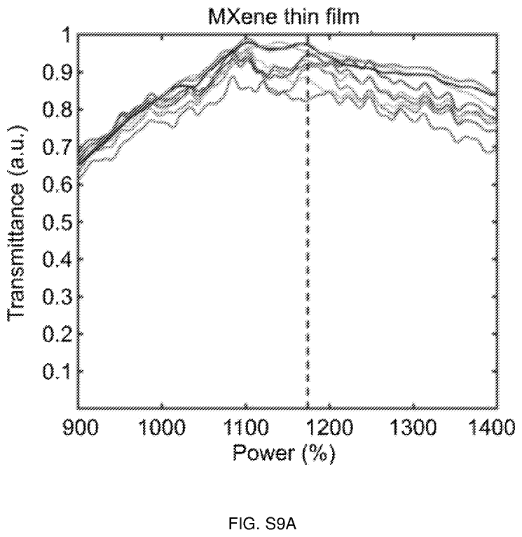

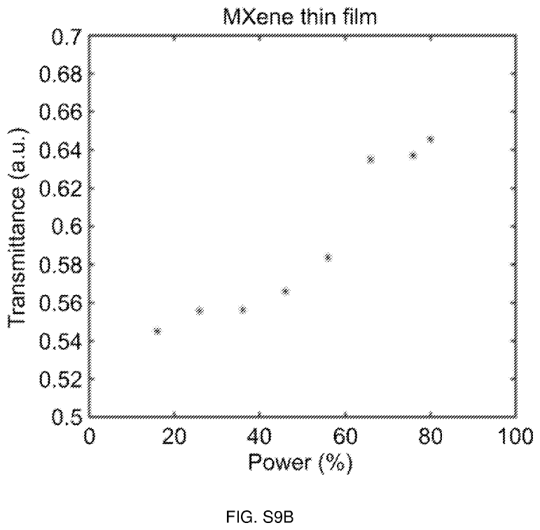

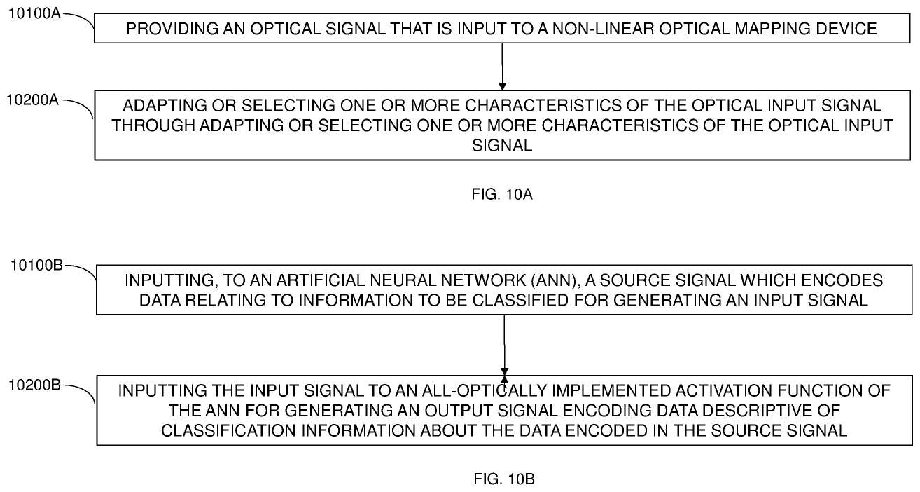

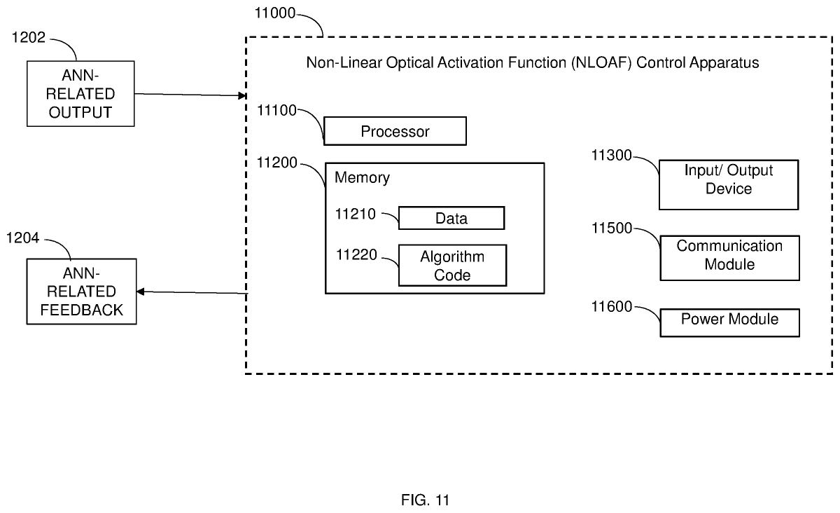

FIGS. S5A-C show graphs relating to a fully connected network for handwritten MNIST digit classification. FIG. S5A-C provide comparisons of loss as a function of epoch count during the training (FIG. 5SA), validation processes (FIG. 5SB), and model accuracy (FIG. 5SC), with proposed all-optical nonlinear activation functions considering MXene metasurface overlayer on waveguide and MXene thin film as compared to software-based nonlinear activation functions.

FIGS. S6A-B show graphs relating to a CNN network for handwritten MNIST digit classifications. FIG. S6A provides comparisons of loss as a function of epoch count during the training.

FIG. S6B provides comparisons of loss as a function of epoch count during the validation, with proposed all-optical nonlinear activation functions considering a MXene metasurface overlayer on waveguide and a MXene thin film as compared to software-based nonlinear activation functions.

FIG. S7 shows a comparison of computational energy efficiency and processing speed between existing electronic neuromorphic demonstrations and the proposed programmable photonic platform.

FIG. S8A is a Zoom-in to a plot of normalized transmission measurement (divided by the measured maximum transmission value) of the device silicon rib waveguide covered with MXene flakes dependence on input power signal varying from 6% to 96%.

FIG. S8B is a plot of Normalized transmission to the output at a wavelength of 1550 nm (dashed line), showing the obtained nonlinear transfer function.

FIG. S9A is zoom-in to a plot of normalized transmission measurement (divided by the measured maximum transmission value) of the MXene thin films with 50 nm thickness on BK-7 substrate dependence on input power signal varying from 6% to 96%.

FIG. S9B is a plot of normalized transmission to the output at a wavelength of 1180 nm (dashed line), showing the obtained nonlinear transfer function.

FIG. 10A shows a flowchart of a method for optically non-linearly activating an optical signal, according to some embodiments.

FIG. 10B shows a flowchart of a method for employing an ANN in which activation functions are optically implemented, according to some embodiments.

FIG. 11 shows an apparatus configured to control characteristics of an optical signal for adapting an activation function of an ANN, according to some embodiments.

### DETAILED DESCRIPTION

Artificial Neural networks are usually implemented electronically, using the ubiquitous Von Neumann computer architecture described back in 1945. Thus, the processing speed of electronically implemented ANNs largely depends on the speed of the electronic components employed.

ANNs have been implemented in numerous integrated photonics applications. These include the optical response prediction of subwavelength nanophotonic devices (Hegde, R. S. (2020) Deep learning: a new tool for photonic nanostructure design. Nanoscale Advances, 2 (3), 1007-1023), neuromorphic computing (Shastri, B. J., Tait, A. N., de Lima, T. F., Pernice, W. H. P., Bhaskaran, H., Wright, C. D., and Prucnal, P. R. (2021) Photonics for artificial intelligence and neuromorphic computing. Nature Photonics, 15 (2), 102-114), obtaining the inverse design for a given optical response (Tahersima, M. H., Kojima, K., Koike-Akino, T., Jha, D., Wang, B., Lin, C., and Parsons, K. (2019) Deep neural network inverse design of integrated photonic power splitters. Sci Rep, 9 (1), 1-9; Liu, D., Tan, Y., Khoram, E., and Yu, Z. (2018) Training deep neural networks for the inverse design of nanophotonic structures. Acs Photonics, 5 (4), 1365-1369; Sajedian, I., Kim, J., and Rho, J. (2019) Finding the optical properties of plasmonic structures by image processing using a combination of convolutional neural networks and recurrent neural networks. Microsyst Nanoeng, 5 (1), 1-8; Qian, C., Zheng, B., Shen, Y., Jing, L., Li, E., Shen, L., and Chen, H. (2020) Deep-learning-enabled self-adaptive microwave cloak without human intervention. Nature Photonics, 14 (6), 383-390; single-pixel cameras that capture coded projections of a scene with a single photodetector and computationally recover them and Hughes, T. W., Williamson, I. A. D., Minkov, M., and Fan, S. (2019) Wave physics as an analog recurrent neural network. Sci Adv, 5 (12), eaay6946Click or tap here to enter text., and others. The utilisation of integrated photonics in ANNs offers a promising alternative approach to microelectronic and hybrid optical-electronic implementations, owing to the improvement in computational speed and power efficiency in machine-learning tasks (Zhang, Q., Yu, H., Barbiero, M., Wang, B., and Gu, M. (2019) Artificial neural networks enabled by nanophotonics. Light: Science & Applications, 8 (1), 1-14. While some works demonstrate partly optically implemented ANNs, non-linear activation functions are still being fulfilled electronically, costing a great deal in time and power consuming operations. Examples of partly optically implemented ANNs where the non-linear activation functions are realized electronically, are described in:
Hughes, T. W., Minkov, M., Shi, Y., and Fan, S. (2018) Training of photonic neural networks through in situ backpropagation and gradient measurement. Optica, 5 (7), 864-871 (HUGHES
Zhang, H., Gu, M., Jiang, X. D., Thompson, J., Cai, H., Paesani, S., Santagati, R., Laing, A., Zhang, Y., and Yung, M. H. (2021) An optical neural chip for implementing complex-valued neural network. Nature Communications, 12 (1), 1-11. (ZHANG);
Zuo, Y., Li, B., Zhao, Y., Jiang, Y., Chen, Y.-C., Chen, P., Jo, G.-B., Liu, J., and Du, S. (2019) All-optical neural network with nonlinear activation functions. Optica, 6 (9), 1132-1137 (ZUO)
Amin, R., George, J. K., Sun, S., Ferreira de Lima, T., Tait, A. N., Khurgin, J. B., Miscuglio, M., Shastri, B. J., Prucnal, P. R., and El-Ghazawi, T. (2019) ITO-based electro-absorption modulator for photonic neural activation function. APL Materials, 7 (8), 81112 (AMIN);
Williamson, I. A. D., Hughes, T. W., Minkov, M., Bartlett, B., Pai, S., and Fan, S. (2019) Reprogrammable electro-optic nonlinear activation functions for optical neural networks. IEEE Journal of Selected Topics in Quantum Electronics, 26 (1), 1-12 (WILLIAMSON); and
Zhou, T., Lin, X., Wu, J., Chen, Y., Xie, H., Li, Y., Fan, J., Wu, H., Fang, L., and Dai, Q. (2021) Large-scale neuromorphic optoelectronic computing with a reconfigurable diffractive processing unit. Nature Photonics, 15 (5), 367-373 (ZHOU).

Accordingly, aspects of embodiments may pertain to an all-optical non-linear activation function realization for a machine learning model implemented for instance by an ANN (e.g., Deep Neural Network), e.g., by realizing non-linear optical signal input-to-output power mapping. For example, aspects of disclosed embodiments pertain to one or more all-optical mapping devices configured for realizing non-linear activation functions in an all-optical manner. Such optical mapping device may comprise an optical unit that is configured to direct an optical input signal from an input interface to an output interface of the optical unit. The optical unit may be implemented on a chip (“on-chip configuration” or on-chip implementation”). It is noted that implementations of all-optically implemented transfer or activation functions are not necessarily limited to ANN-related implementations but may also be employed in other machine learning models and computational tasks.

It is noted that, in some embodiments, different building blocks or layers of a given neural network may employ or effect different all-optical activation functions. In some other embodiments, the all-optical activation functions of a given neural network may be identical or substantially identical with each other.

In some examples, the ANN may be implemented in an all-optical manner. In some examples, only some or all operators (e.g., non-linear activation functions, Maximum Pool, Convolution) of the ANN may be implemented optically.

The optical mapping device may comprise a substance causing the mapping device to have saturable absorption characteristics such that absorption of an optical signal guided from the input interface to the output interface by the optical unit (e.g., non-linearly) decreases with an increase in optical signal intensity received by the optical unit. Conversely, absorption of an optical signal guided from the input interface to the output interface by the optical unit (e.g., non-linearly) increases with a decrease in optical signal intensity received by the optical unit. In some examples, the saturable absorber characteristics of the optical unit are adaptable. In some examples, the saturable absorber characteristics are adaptable on-the-fly while the optical unit is in use. In some examples, the optical mapping device may comprise an optical unit that is treated by the substance for the mapping device to attain saturable absorption characteristics.

In some embodiments, the optical unit may include an optical element that includes and/or is being overlayed and/or treated with a substance having properties causing the mapping device to exhibit saturable absorber characteristics.

In some embodiments, the optical unit includes a waveguide covered with or overlayed by a substance having saturable absorber characteristics to realize the optical mapping device. Such configuration may herein also be referred to as an “inline setup”. In some examples, the waveguide may include a rib waveguide, a strip waveguide, and/or a diffused waveguide.

In some embodiments, the optical unit includes a substrate covered with a thin film substance for implementing the mapping device, arranged perpendicular or about perpendicular to a propagation direction of the optical signal. Such configuration may herein be referred to as a “thin film setup” or “free space setup”.

In some examples, saturable absorber characteristics of the substance relate to optical and/or plasmon-related characteristics.

In some embodiments, optical responses of the nonlinear activation function shape may be selected through by adapting one or more characteristics of an optical (input) signal that is input to at least one or all nodes of an input layer of an ANN. Such optical signal (e.g., laser) characteristics can include, for example, wavelength, lasing mode, polarization, and/or phase. Transfer functions of a mapping device represent the device's nonlinear optical responses by output power vs input power relation. It was noted that these observed nonlinear functions represent a subset of functions achievable by the employed devices without modifying the structure of the devices.

In some examples, parameter values (e.g., accuracy, loss in model training) relating to classification output provided by a partially or all-optically implemented ANN may be used a feedback for (e.g., continuously) adapting, if required, input signal characteristics to adapt all-optically implemented non-linear activation functions, e.g., to increase accuracy and/or reduce loss during training of the ANN. For example, in case characteristics (e.g., parameter values) of classification output does not meet a classification criterion (e.g., below an accuracy threshold value, above a loss threshold value), then the characteristics may be adapted until the classification criterion is met. Some or all signals processed by the ANN may be optical signals. An ANN according to embodiments may be partially or all-optically implemented.

In some embodiments, initial optical characteristics may be preselected or predetermined (e.g., by the user, or prestored in the system as a default). The initial optical characteristics may be adapted to obtain adapted optical characteristics, based on the determined initial ANN operating characteristics, to obtain correspondingly adapted ANN operating characteristics. The initial optical characteristics may be adapted in case one or more ANN operating criteria or classification criteria (relating, e.g., to accuracy and/or loss) are not met.

In some embodiments, the substance includes or consists of MXene family of materials (e.g., Ti₃C₂Tₓ) and/or Graphene. MXenes comprise a large class of 2D transition metal carbides and nitrides such as Ti₃C₂Tₓ, where “Tₓ” represents surface terminations such as —O, —OH and —F), as for example described in “Anasori, B., and Gogotsi, Y. G. (2019) 2D metal carbides and nitrides (MXenes), Springer” (ANASORI); and in “Tian, W., Vahid Mohammadi, A., Reid, M. S., Wang, Z., Ouyang, L., Erlandsson, J., Pettersson, T., Wågberg, L., Beidaghi, M., and Hamedi, M. M. (2019) Multifunctional nanocomposites with high strength and capacitance using 2D MXene and 1D nanocellulose. Advanced Materials, 31 (41), 1902977” (TIAN).

MXenes exhibit unique light-matter interactions such as the nonlinear effect of saturable absorption on one hand as for example, described in “Wang, G., Bennett, D., Zhang, C., Ó Coileáin, C., Liang, M., McEvoy, N., Wang, J. J., Wang, J., Wang, K., and Nicolosi, V. (2020) Two-photon absorption in monolayer MXenes. Advanced Optical Materials, 8 (9), 1902021” (WANG); “(Dong, Y., Chertopalov, S., Maleski, K., Anasori, B., Hu, L., Bhattacharya, S., Rao, A. M., Gogotsi, Y., Mochalin, V. N., and Podila, R. (2018) Saturable absorption in 2D Ti3C2 MXene thin films for passive photonic diodes. Advanced Materials, 30 (10), 1705714) (DONG), and plasmonic properties on the other hand (“Maleski, K., Shuck, C. E., Fafarman, A. T., and Gogotsi, Y. (2021) The Broad Chromatic Range of Two-Dimensional Transition Metal Carbides. Advanced Optical Materials, 9 (4), 2001563” (MALESKI).

Furthermore, integrating MXene in photonic circuits is extremely useful for the all-optical nonlinear activation function in NN. MXene on a chip is affordable and simple to fabricate architecture

In some embodiments, the substance includes a suspension containing MXene flakes dispersed in a medium.

In some examples, MXene concentration in the fluid covering the waveguide or the substrate is adaptable, e.g., during use of the optical unit. For example, MXene concentration in the fluid is adaptable while an optical signal is propagating from the input to the output of the optical unit.

In some embodiments, the optical mapping device is configured such that MXene concentration in the fluid is adaptable while an optical signal is propagating from the input to the output of the optical unit.

In some embodiments, the wavelength of the optical signal ranges from the IR to the UV spectrum.

In some embodiments, the optical unit is operable to provide non-linear activation mapping functionality at temperature ranging from 10-30 degrees Celsius at an optical input power ranging from 0.1 μm to about 1000 mW.

In some embodiments, the optical unit is operable to implement, due to its non-linear absorption characteristics, a Non-Linear Activation Function (NLAF) of a neuron of, e.g., an Artificial Neural Network (ANN). In some examples, the ANN may be a convolutional NN (CNN), a feedforward neural network, and/or a recurrent neural network.

The connectivity to other (e.g., all-optically implemented) neurons can be implemented via the output of optical units according to embodiments, and can induce the next all-optically implemented neuron in the neural network.

Embodiments may also pertain to a system for optically implementing an artificial neural network. Such system may comprise an array of input waveguides configured to receive a first array of optical signals and at least one all-optical mapping device, which may a non-linear optical mapping device.

The system may further comprise an optical interference unit that is in optical communication with the array of input waveguides and the at least one optical mapping device. The optical interference unit is operable to perform a linear transformation on the first array of optical signals resulting in a second optical signal representing the linear transformation result and that is input to the at least one optical mapping device to apply a non-linear activation function on the second optical signal to obtain a third optical signal representing non-linear mapping between the second and the third optical signal.

In some embodiments, the optical unit and/or the system may be implemented by Integrated Photonics to provide a stable, compact and robust platform for the implementation of complex electronic circuits.

In some embodiments, the all-optical implementation of the ANN may have a time delay on the order of picoseconds.

In some examples, since the system employs a mapping device including an optical unit operable to optically realize a non-linear activation function, the system for optically implementing an ANN may be free of devices that convert an optical input signal into a corresponding electronic input signal for electronically realizing on the electronic input signal, the non-linearity function to produce a related electronic output signal. Furthermore, the system for optically implementing an ANN may be free of devices that convert the related electronic output signal back into an optical output signal. This way, the computational speed of the all-optically implemented ANN may be increased significantly (e.g., at least five-fold, compared to ANNs which include electronic circuitry to implement some of the ANNs functionalities). In some examples, the response time of the all-optical ANN is the speed of light in matter namely c/n (considering for example n of silicon at 1550 nm, which is 3.48). Embodiments of the proposed ANNs thus compete with convention von Neumann computer architecture.

In some embodiments, the mapping device, or the optical unit included in the mapping device, may not require the controlling of electronic devices and/or may not require temperature or thermal control (e.g., cooling) to achieve or maintain the desired operating parameters and/or classification accuracy. For example, for an optical input power to an optical unit ranging, for example, from 0.1 mW to 1000 mW, the operational working temperature of an ANN employing a plurality of such optical units can range from 10-30 degrees Celsius. Therefore, in some examples, the all-optical ANN may be operable at room temperature ranging for example from 10-30 degrees, without requiring cooling of any of the elements employed by the all-optical ANN.

Example Experiments demonstrated the optical neuron nonlinear activation function based on nanophotonic structures. The following was employed in the experiment:
1) a saturable absorber made of Ti3C2Tx MXene thin film, and
2) a nanophotonic silicon-on-insulator multimode rib waveguide covered with MXene flakes.

These were tested experimentally, and a NN-based emulator was developed to analyze the results. The nonlinear activation function with executed MNIST handwritten digit classification task reported was of 99.1% accuracy.

In some embodiments, a fundamental building block of an ANN that is implemented, for example, as a fully integrated DNN, may include at least one optical unit comprising one or more optical elements and MXene optically interactively coupled with the one or more optical elements, such that the optical unit allows or effects non-linear mapping characteristics of input to output light signal. The optical element may incorporate MXene, may be overlaid with MXene, and/or otherwise be operably subjected to or coupled with MXene. For example, the optical unit may include or be implemented by one or more waveguides, lens elements, diffractive elements, filters, substrates, and/or the like, overlaid with MXene, for example, in the form of flakes suspended in a suspension (also: “MXene-dispersed suspension”).

Optical input signals carrying encoded information may pass through an Optical Linear Combiner Structure of a node of a present layer of the ANN to undergo linear combination. The optical signals input to the Optical Linear Combiner Structure may be the output of a node of a preceding building block of the corresponding preceding layer. The Optical Linear Combiner Structure may produce a signal light output which is input to the Optical Nonlinearity Unit of the node of the present layer, for providing, at the output of the Optical Nonlinearity Unit, a nonlinearly mapped signal response output. The nonlinearly mapped signal response output is then input to the corresponding next building block of the subsequent layer.

In some examples, a plurality of all-optical building blocks may be arranged for all-optically implementing an ANN. The input-output of such all-optical ANN may realize a function ƒ: [symbol] → [symbol] , where n and m (n, m≥1) are the number of neurons in the input and output layers, respectively.

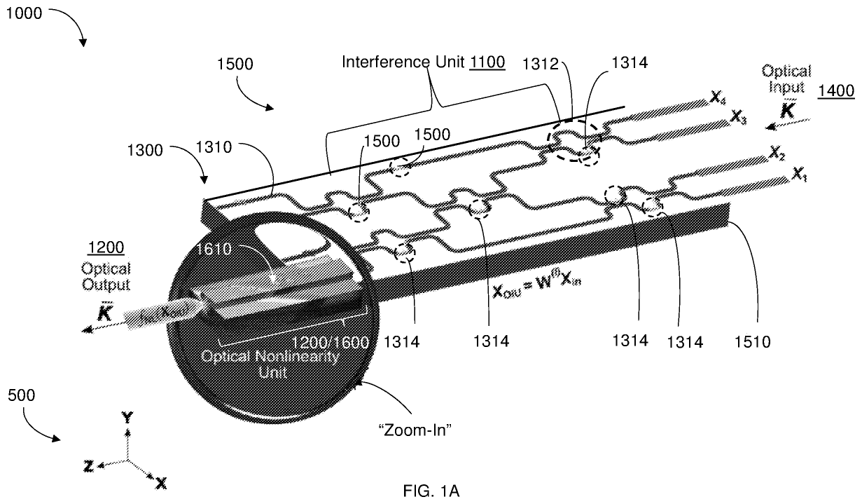

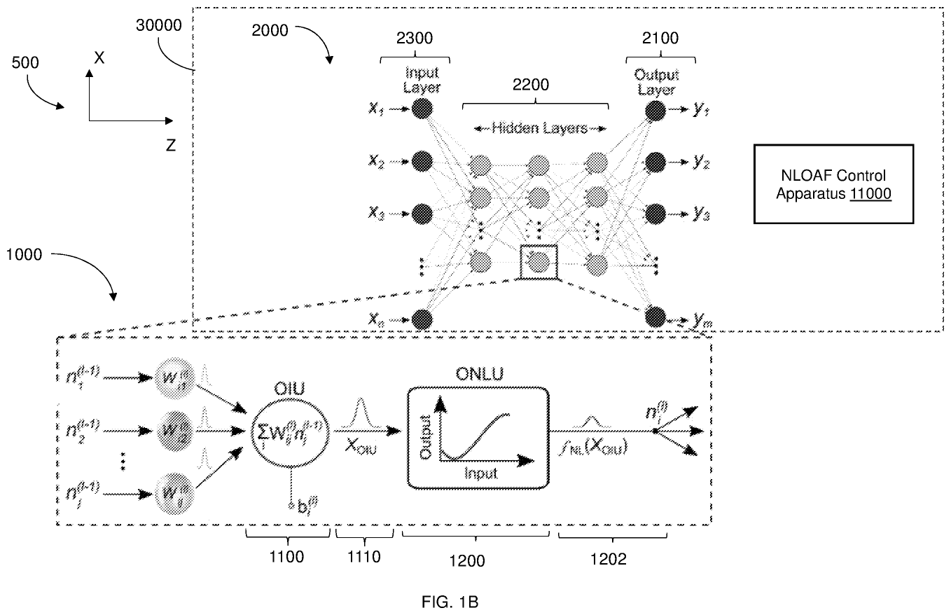

Reference is now made to FIG. 1A, schematically illustrating an all-optically implemented ANN building block 1000 of an ANN. ANN building block 1000 may include an Optical Interference Unit 1100 and a Non-Linear Optical Mapping Device 1200, e.g., of a deep neural network (DNN).

Elements of ANN building block 1000 may at least partially be implemented by a photonic circuit 1300. Photonic Circuit 1300 is schematically illustrated as being disposed on or integrated with a substrate 1510 of a chip 1500. Coordinate system 500 shown in FIG. 1A may be a local coordinate system to chip 1500. In other words, chip 1200 may be referred to as the reference frame for the purposes of the present disclosure.

Photonic circuit 1300 may include one or more waveguides 1310 operative to receive input light signals 1400 from a plurality of inputs X1-Xn. Each received input light signal Xi encodes information for processing by the ANN. The arrows indicate the propagation direction of the input light, which may for example be laser light.

Photonic circuit 1300 may be configured to implement Optical Interference Unit 1100 and Non-Linear Optical Mapping Device 1200.

Optical Interference Unit 1100 is operable to perform a linear transformation on the optical input signals Xn received at a first array of input waveguides of the photonic circuit 1300.

In some examples, photonic circuit 1300 may be configured to implement a mesh of Mach Zehnder interferometers. However, the illustrated implementation is not to be construed in a limiting manner. Accordingly, additional or alternative photonic circuit configurations may be employed than the one shown in FIG. 1A. A Mach-Zehnder interferometer may for example be implemented by directional couplers, schematically illustrated in FIG. 1A as curved sections 1312 of the waveguides, optionally including phase shifters 1314, for controlling a splitting ratio and differential output phase. It is noted that not all couplers and/or phase shifters may be designated in FIG. 1A by reference numerals.

The zoom-in illustrates a (e.g., rib) waveguide 1600 for implementing Non-Linear Optical Mapping Device 1200 to obtain a neuron's nonlinear activation function (ƒ_{NL}(X_{OIU})) based on light-MXene interaction. Rib waveguide 1600 is covered with MXene flakes 1610 for implementing the all-optical non-linear mapping device including the all-optical Optical (Nonlinearity) Unit.

Additional reference is made to FIG. 1B. A general architecture of a fully connected ANN 2000 (e.g., for implementing a DNN) comprises an input layer 2100, several hidden layers 2200, and an output layer 2300. A diagram of an ANN building block 1000 is shown with respect to a selected neuron of a selected hidden layer 2200. Input signals n1-nj of the selected neuron are weighted, input to and combined by the corresponding Optical Interference Unit 1100, which produces an interference output signal 1110 which is then input to the Non-Linear Optical Mapping Device 1200. Non-Linear Optical Mapping Device 1200 includes or implements the optical non-linearity unit for applying the all-optical non-linear activation function ƒ_{NL}(X_{OIU}) on the received interference output signal 1110 to produce signal output 1202.

It is noted that non-linear mapping device 1200 may be employed in various ANN architectures, and is therefore not limited to those schematically illustrated in the accompanying figures.

In some embodiments, one or more Optical Interference Unit 1100 of an all-optical ANN can be realized using various integrated photonics architectures to implement matrices multiplication for weighting and summation.

The physical implementation can for example be classified as optical modes realization such as linear operation nanophotonics circuits, as described, for example, in
Zhang, H., Gu, M., Jiang, X. D., Thompson, J., Cai, H., Paesani, S., Santagati, R., Laing, A., Zhang, Y., and Yung, M. H. (2021) An optical neural chip for implementing complex-valued neural network. Nature Communications, 12 (1), 1-11 (ZHANG);
Shen, Y., Harris, N.C., Skirlo, S., Prabhu, M., Baehr-Jones, T., Hochberg, M., Sun, X., Zhao, S., Larochelle, H., and Englund, D. (2017) Deep learning with coherent nanophotonic circuits. Nature Photonics, 11 (7), 441-446 (SHEN);
Hu, J., Lang, T., Hong, Z., Shen, C., and Shi, G. (2018) Comparison of electromagnetically induced transparency performance in metallic and all-dielectric metamaterials. Journal of Lightwave Technology, 36 (11), 2083-2093 (HU);
Carolan, J., Harrold, C., Sparrow, C., Martin-López, E., Russell, N.J., Silverstone, J. W., Shadbolt, P. J., Matsuda, N., Oguma, M., and Itoh, M. (2015) Universal linear optics. Science (1979), 349 (6249), 711-716 (CAROLAN); and
Chiles, J., Buckley, S. M., Nam, S. W., Mirin, R. P., and Shainline, J. M. (2018) Design, fabrication, and metrology of 10×100 multi-planar integrated photonic routing manifolds for neural networks. APL Photonics, 3 (10), 106101 (CHILES).

In some embodiments, the all-optical ANN may employ one or more Optical Interference Units 1110 which are based on multiwavelength realization such as parallel weighting of optical carrier signals generated from wavelength-division multiplexing using microring resonators weight banks, as for example, described in:
Tait, A. N., Nahmias, M. A., Shastri, B. J., and Prucnal, P. R. (2014) Broadcast and weight: an integrated network for scalable photonic spike processing. Journal of Lightwave Technology, 32 (21), 4029-4041 (Tait2014);
Feldmann, J., Youngblood, N., Wright, C. D., Bhaskaran, H., and Pernice, W. H. P. (2019) All-optical spiking neurosynaptic networks with self-learning capabilities. Nature, 569 (7755), 208-214 (Feldmann);
Tait, A. N., Wu, A. X., De Lima, T. F., Zhou, E., Shastri, B. J., Nahmias, M. A., and Prucnal, P. R. (2016) Microring weight banks. IEEE Journal of Selected Topics in Quantum Electronics, 22 (6), 312-325 (Tait2016).
Tait, A. N., De Lima, T. F., Zhou, E., Wu, A. X., Nahmias, M. A., Shastri, B. J., and Prucnal, P. R. (2017) Neuromorphic photonic networks using silicon photonic weight banks. Sci Rep, 7 (1), 1-10 (Tait2017);
Bangari, V., Marquez, B. A., Miller, H., Tait, A. N., Nahmias, M. A., De Lima, T. F., Peng, H.-T., Prucnal, P. R., and Shastri, B. J. (2019) Digital electronics and analog photonics for convolutional neural networks (DEAP-CNNs). IEEE Journal of Selected Topics in Quantum Electronics, 26 (1), 1-13 (Bangari);

Multiwavelength-based realization of Optical Interference Units 1100 may process weighted optical input signals as follows: For multiple weighted Wᵢⱼ^{(l)} input signals nⱼ^{(l-1)} arriving from the output of neurons in the previous layer with the addition of a bias bᵢ^{(l)}, the optical linear interface of the i^{th} neuron nᵢ^{(l)} in the layer l^{th}, is given by a linear operation across all the inputs, i.e., nᵢ^{(l)}=bᵢ^{(l)}+ΣⱼWᵢⱼ^{(l)}nⱼ^{(l-1)}.

In some implementations, Optical Interference Unit 1100 building block may be emulated in DNN modelling by considering the analytical form of a whole layer output X_{OIU}^{(l)}, as follows: X_{OIU}^{(l)}=W^{(l)}Y^{(l-1)}, through the forward-propagation procedure. For instance, weighted input signals can be implemented with a nanophotonic circuit of integrated Mach-Zehnder interferometers, each formed of waveguides and 50:50 directional couplers which are combined with phase shifters (ZHANG), (SHEN).

Where any unitary transformations can be implemented with conventional optical beamsplitters and phase shifters, as for example, described in Reck, M., Zeilinger, A., Bernstein, H. J., and Bertani, P. (1994) Experimental realization of any discrete unitary operator. Phys Rev Lett, 73 (1), 58, rectangular diagonal matrix can be implemented with optical attenuation achieved by Mach-Zehnder modulator.

Furthermore, implementations of an Optical Interference Unit relying on free-space diffractive DNN, as for example described in
Lin, X., Rivenson, Y., Yardimci, N. T., Veli, M., Luo, Y., Jarrahi, M., and Ozcan, A. (2018) All-optical machine learning using diffractive deep neural networks. Science (1979), 361 (6406), 1004-1008, (LIN);
Luo, Y., Mengu, D., Yardimci, N. T., Rivenson, Y., Veli, M., Jarrahi, M., and Ozcan, A. (2019) Design of task-specific optical systems using broadband diffractive neural networks. Light: Science & Applications, 8 (1), 1-14 (LUO); and
Li, Y., Chen, R., Sensale-Rodriguez, B., Gao, W., and Yu, C. (2021) Real-time multi-task diffractive deep neural networks via hardware-software co-design. Sci Rep, 11 (1), 1-9 (LI)
   has already been shown in the spectral domain (see also:
Giambagli, L., Buffoni, L., Carletti, T., Nocentini, W., and Fanelli, D. (2021) Machine learning in spectral domain. Nat Commun, 12 (1), 1-9.
Li, J., Mengu, D., Yardimci, N. T., Luo, Y., Li, X., Veli, M., Rivenson, Y., Jarrahi, M., and Ozcan, A. (2021) Spectrally encoded single-pixel machine vision using diffractive networks. Science Advances, 7 (13), eabd7690.

In embodiments, where diffraction light interference implements the weighting, a sum of these signals may be achieved through combined transmission (or reflection) coefficients at each point on a given transmissive layer that acts as a neuron. However, an Optical Interference Unit alone is insufficient for a photonic device to act as a building block in ANN (e.g., DNN) applications, as some optical nonlinearities may have to be introduced.

In embodiments, an all-optically implemented non-linear optical input to optical mapping device generates an optical output signal by processing the multiple optical inputs signals X_{OIU}^{(l)}, through the all-optically implemented nonlinear activation function, nᵢ^{(l)}=ƒ_{NL}(X_{OIU}^{(l)}). By realizing the mapping device, for example, with the disclosed light-MXene interaction, a nonlinear activation function can be realized in an all-optical manner, obviating the need of optical-to-electrical signal conversion followed by electrical-to-optical signal conversion.

Example Experimental Design and Fabrication of Mxene-Based all-Optical Nonlinear Activation Function

Focusing on the nonlinearity optical unit, all-optical nonlinear activation functions utilizing unique light-matter interactions in 2D Ti₃C₂Tₓ-MXene were studied, which included the validation of the all-optical ANN performance by focusing on the shape of the activation functions.

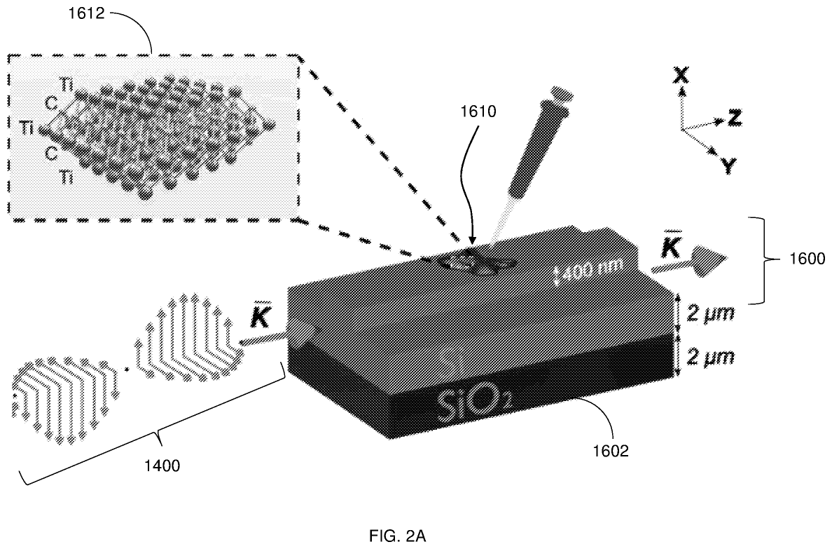

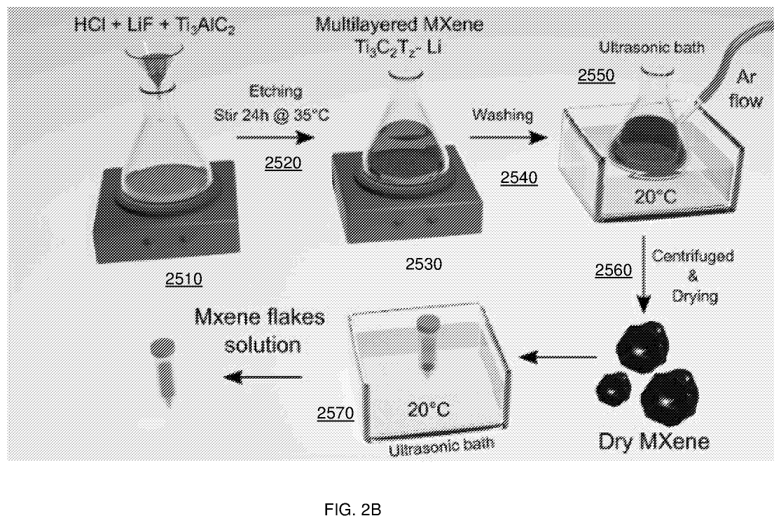

Additional reference is made to FIGS. 2A-4A.

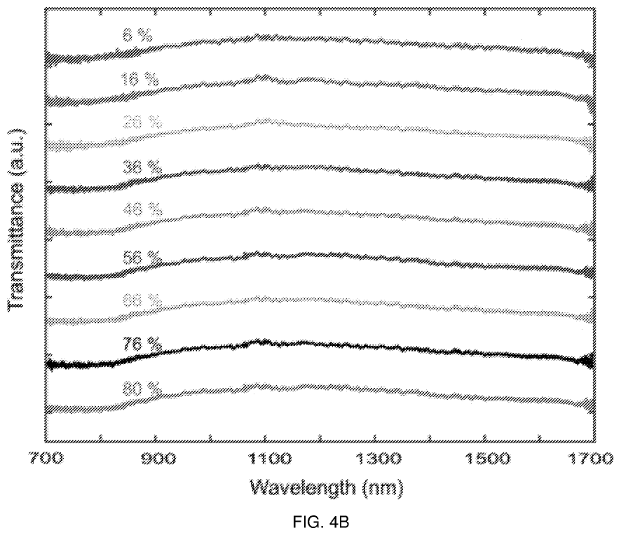

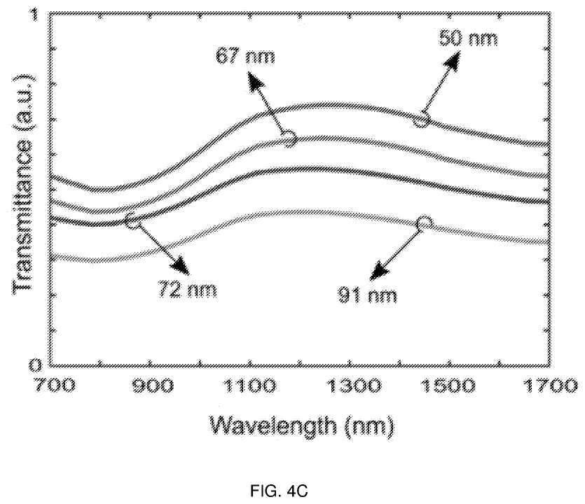

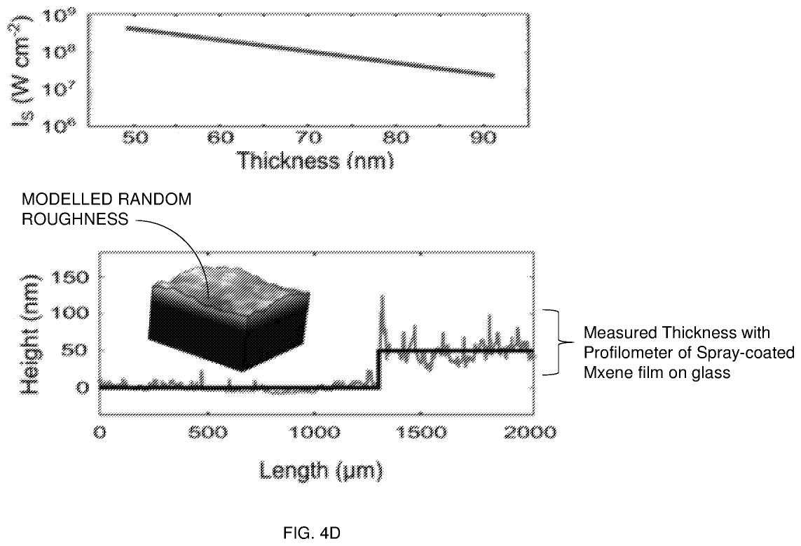

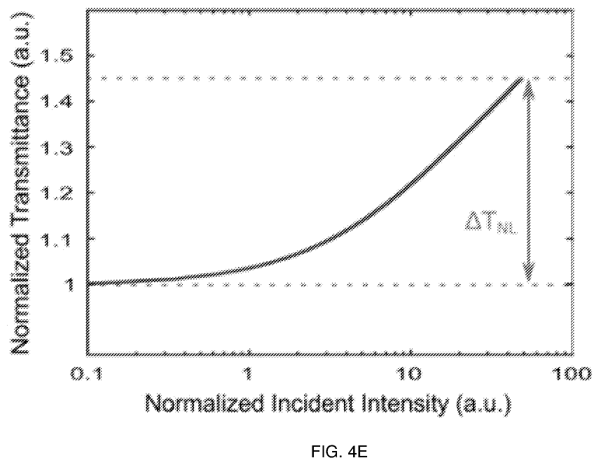

Two devices were designed to introduce the all-optical nonlinear activation function. FIG. 2a and inset of FIG. 4A schematically show rendered images of studied architectures to demonstrate the concept of an all-optical nonlinear activation function with an MXene overlayer. As schematically shown in FIG. 2A, non-polarised electromagnetic wave (also: light, optical signal) 1400 illuminates the in-facet of a multimode rib waveguide 1600 (e.g., made of Si) overlaying a waveguide substrate 1602 (e.g., made of SiO2). shown schematically to be covered with a substance 1610 having saturable absorber characteristics (e.g., MXene flakes).

It is noted that the details (e.g., materials, dimensions) of any example implementations illustrated in and/or described herein in conjunction with the accompanying figures shall not be construed in a limiting manner with respect to possible implementations of embodiments.

For example, the rib waveguide may be made of varied materials and/or have different dimensions than those mentioned in FIG. 2A. In addition, although light 1400 is schematically shown as being unpolarized, this is not to be construed in a limiting manner, and the incoming light may in some embodiments be polarized (e.g., linear, circular, elliptical). Inset 1612 schematically shows the crystal structure of a 2D MXene monolayer, Ti₃C₂Tₓ.

In one example, the interaction with the substance (e.g., MXene) overlayer may take place via evanescent waves. In another example, the (e.g., unpolarized) plane electromagnetic wave may illuminate the thin film of the substance overlaying on an (e.g., glass) substrate or any other transparent or substantially-transparent or semi-transparent substrate, as schematically shown in the inset of FIG. 4A.

To study the nonlinear response of fabricated samples, two experimental setups operating in a broad spectral range were constructed. For MXene thin films, a coherent supercontinuum generation laser source was focused on the film, and then the light was collected by an optical spectrum analyzer (OSA) via a fibre. For the on-chip configuration or implementation, the rib waveguide covered with MXene flakes was butt-coupled via single-mode fiber, then the light was collected by OSA via a multimode fibre. In addition, the rib waveguide surfaces were imaged on the camera for inspection, characterization and alignment.

### Example Experiment for the Formation of Mxene Flake-Based Metasurface on a Waveguide

It is noted that embodiments may be implemented differently than discussed in the example experiment setups discussed herein. For example, diverse types of coupling fibers and/or waveguides and/or substances may be employed.

One possibility that was considered for inducing an optical nonlinearity in a photonic integrated circuit is by exploiting a hybrid system including a silicon waveguide with a MXene flake overlayer.

FIG. 2A schematically shows a rendered image of studied architecture on a chip to demonstrate the concept of an all-optical nonlinear activation function with an MXene overlayer. Non-polarised electromagnetic wave illuminates the in-facet of a multimode rib waveguide. The interaction with the MXene overlayer takes place via evanescent waves and 1) leads to some losses within the material, and 2) causes the scattering of light in all directions.

In the example, the rib waveguide was wide enough to support multiple modes to increase the coupling between the evanescent waves and MXene nano-flakes. This can be achieved with the higher-order modes that have a longer evanescent field extension into the medium and larger field amplitude at the waveguide cladding interface, compared to the fundamental and lower modes. To produce an MXene metasurface (a metasurface is a patterned thin film composed of elements at a subwavelength scale to achieve tailored properties), the first Ti₃C₂Tₓ MXene was synthesised through selective chemical etching using the LiF+HCl method (Ghidiu, M., Lukatskaya, M. R., Zhao, M.-Q., Gogotsi, Y., and Barsoum, M. W. (2014) Conductive two-dimensional titanium carbide ‘clay’ with high volumetric capacitance. Nature, 516 (7529), 78-81). Click or tap here to enter text. Then, to realize an MXene-based metasurface, a diluted MXene suspension in water with 0.01 g/ml was prepared and drop-casted on a waveguide. FIG. 2B shows a schematic illustration describing the synthesis process of MXenes from MAX phases and redispersion of the dry product to produce MXene dispersed suspension.

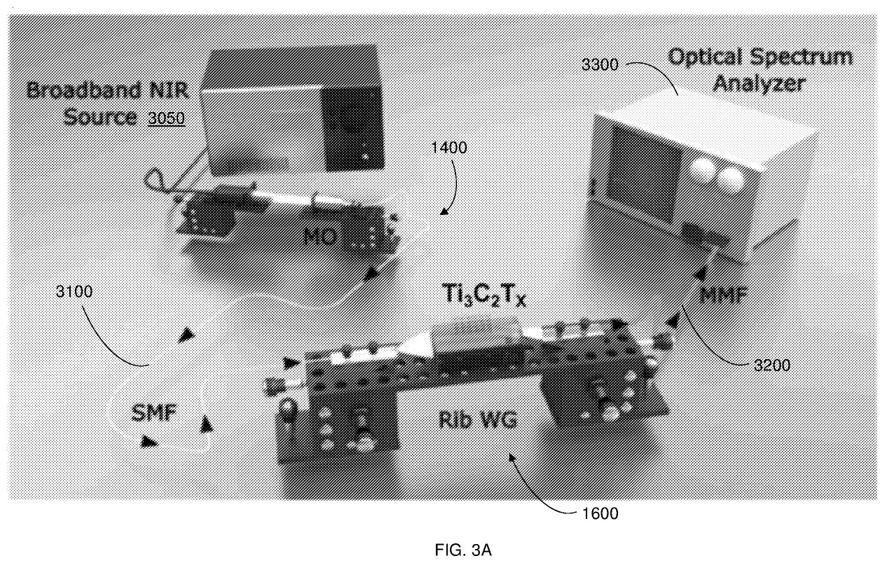

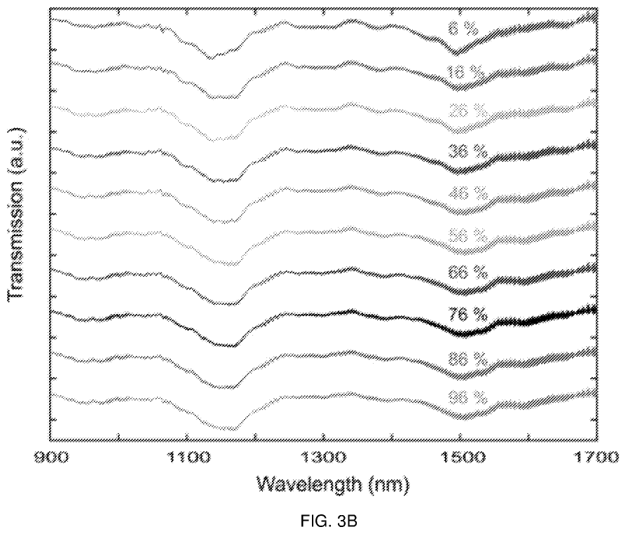

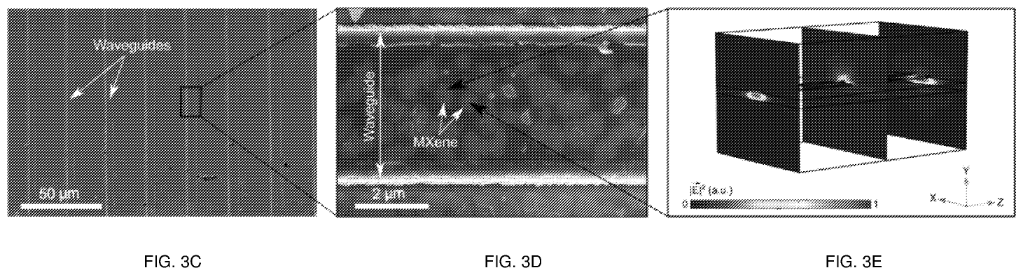

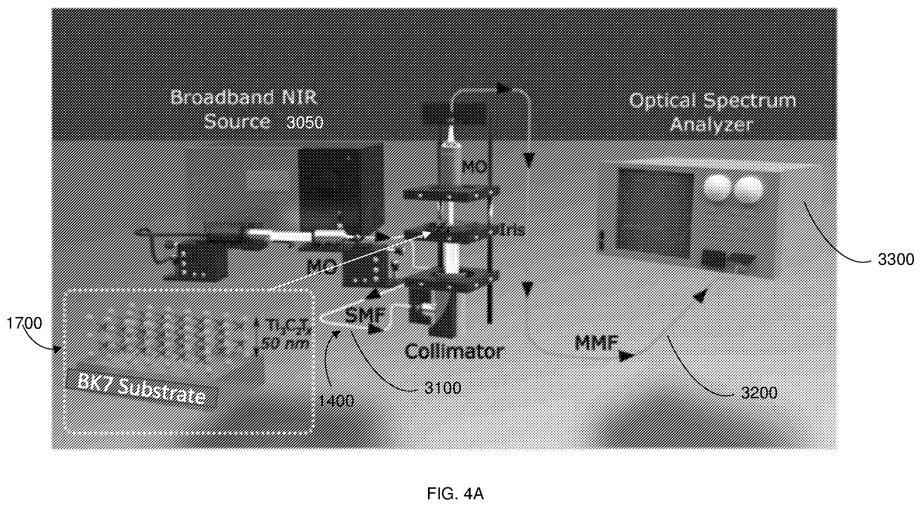

A silicon rib waveguide was fabricated with an MXene flakes overlayer. FIG. 3A shows the schematics of an inline experimental setup operating with broadband illumination to test such waveguides.

In the example experiment broadband input light 1400 originating from a light source 3050 is coupled to the waveguide 1600 by a first fiber 3100 (a single mode fiber or SMF)) and collected from the output facet of the waveguide 1600 by a second fiber 3200 (a multimode or MMF fiber) into a spectrum analyzer 3300.

FIG. 3B shows transmission spectra graphs collected via multimode fibre from the distal end of the waveguides with strip width of 4 μm covered by an MXene flake-based metasurface. The graphs show well-pronounced spectral signatures: a dip around 1180 nm with a depth of −25 dB and a dip around 1490 nm with a depth of −20 dB. These dips can be associated with plasmonic excitation oriented MXene flakes on the waveguide surface.

The measured transmission spectra from silicon rib waveguide covered with MXene flakes for input power varying from 6% to 96% (from top to bottom).

Plasmonic excitation in MXene arises from a plasmon-induced increase in the ground state absorption at photon energies above the threshold for free carrier oscillations (Dong, Y., Chertopalov, S., Maleski, K., Anasori, B., Hu, L., Bhattacharya, S., Rao, A. M., Gogotsi, Y., Mochalin, V. N., and Podila, R. (2018) Saturable absorption in 2D Ti3C2 MXene thin films for passive photonic diodes. Advanced Materials, 30 (10), 1705714. (DONG))

The dip in transmission spectrum around 1490 nm, schematically shown in FIG. 3B, can be associated with the first overtone excitation of —OH functional group out-of-plane vibrations of MXene (Satheeshkumar, E., Makaryan, T., Melikyan, A., Minassian, H., Gogotsi, Y., and Yoshimura, M. (2016) One-step solution processing of Ag, Au and Pd@MXene hybrids for SERS. Sci Rep, 6 (1), 1-9) (SATHEESHKUMAR).

The first principle calculation (Hu, T., Wang, J., Zhang, H., Li, Z., Hu, M., and Wang, X. (2015) Vibrational properties of Ti 3 C 2 and Ti 3 C 2 T 2 (T=O, F, OH) monosheets by first-principles calculations: a comparative study. Physical Chemistry Chemical Physics, 17 (15), 9997-10003 (HU) verifies the fundamental vibration related to this overtone. The dip in transmission around 1180 nm can be associated with the waveguide shifted overtone vibration of MXene metasurface assigned to the OH/H₂O native oxide layer on the waveguide surface, or with plasmonic excitation, because the real part of the permittivity of MXene is negative in this range—as can be seen from the dispersion spectra we measured with ellipsometry (shown in Supplementary FIG. S1). In addition, the nanoscale flakes of MXene can exhibit a nano-antenna effect resulting in resonances appearing in transmission spectra. The shallow peak around 980 nm corresponds to the minor peak shown in FIG. 3b and can be explained by the MXene dispersion as measured with an ellipsometer (see Supplementary FIG. S1).

FIG. 3C schematically shows a scanning electron micrograph of the top view on reference waveguides, while FIG. 3D schematically shows a scanning electron micrograph of the top view on waveguides covered by an MXene flake-based metasurface overlayer. More specifically, FIG. 3C shows top view scanning electron microscope (SEM) images of blank reference waveguides, and FIG. 3D shows metasurface overlayer of MXene on a rib waveguide.

FIG. 3E schematically shows calculated field distribution of optical mode propagating in the waveguide core and interacting with MXene nanodiscs indicated by arrows in subplot d with the dispersion of MXene.

To better understand the light-matter interaction, specifically the interaction between the evanescent waves and MXenes overlayer, a unit cell effect was numerically explored, where the unit cell is made of two MXene nanodiscs atop the silicon, illuminated by the evanescent waves studied rib waveguide. Calculated results show the extinction cross-section curve as in Supplementary FIG. S3a with two peaks. The smaller peak appears at a shorter wavelength (around 1020 nm), while the larger peak appears at a longer wavelength (around 1560 nm). Supplementary FIG. S3b shows the power loss density in a slice through the MXene nanodiscs to assess the intensity dependence in the proposed hybrid system.

### Example Experimental Implementation of an Mxene Saturable Absorber

A further alternative approach to realize the nonlinear activation function is utilizing the optical nonlinearity via the effect of saturable absorption, for which the absorption decreases with an increase in the input light intensity. This could for example be expressed by the material absorption coefficient at a given wavelength as

$$α = \frac{{α}_{0}}{1 + I / {I}_{S}} ,$$

where α₀ is the linear absorption coefficient, I and I_{S} are the incident and saturation intensities. Hence, in some embodiments, the mapping device may be implemented in a (e.g., free-space) setup where the substance (e.g., in a thin film overlaying a substrate) is subjected to incident light. The transmission spectra may depend on the thin film thickness and/or the incident light characteristics. The light may be considered to be incident to the substance in a direction which is perpendicular or about perpendicular to the substance thin film layer, e.g., in contrast to the waveguide implementation which may be based on the effect, e.g., evanescent waves.

2D Ti₃CNT, was found to exhibit nonlinear saturable absorption at higher light fluence, as described in:
Dong, Y., Chertopalov, S., Maleski, K., Anasori, B., Hu, L., Bhattacharya, S., Rao, A. M., Gogotsi, Y., Mochalin, V. N., and Podila, R. (2018) Saturable absorption in 2D Ti3C2 MXene thin films for passive photonic diodes. Advanced Materials, 30 (10), 1705714; and
Wu, Q., Jin, X., Chen, S., Jiang, X., Hu, Y., Jiang, Q., Wu, L., Li, J., Zheng, Z., and Zhang, M. (2019) MXene-based saturable absorber for femtosecond mode-locked fiber lasers. Opt Express, 27 (7), 10159-10170.

In addition, it was shown that the saturation fluence and modulation depth of Ti₃CNTX-MXene depend on the film thickness, as described in Dong, Y., Chertopalov, S., Maleski, K., Anasori, B., Hu, L., Bhattacharya, S., Rao, A. M., Gogotsi, Y., Mochalin, V. N., and Podila, R. (2018) Saturable absorption in 2D Ti3C2 MXene thin films for passive photonic diodes. Advanced Materials, 30 (10), 1705714.

To experimentally extract the nonlinear optical response, four spray-coated samples of thin films of Ti₃C₂Tₓ on BK-7 glass were fabricated, with an increasing thickness between 50 nm and 90 nm. To observe the saturable absorption property of MXene thin-film via free-space illumination measurement, unpolarized light was used for illuminating a 50 nm MXene film on a BK-7 substrate and collected via the focusing objective into the multimode optical fiber directly connected to the optical spectrum analyzer 3300 illustrated in FIG. 4A.

Rendered transmission setup with inset showing a thin film 1700 of Ti₃C₂Tₓ on BK-7 glass; Microscope objective (MO), first fiber 3100 (Single-mode fibre (SMF)), second fiber 3200 (Multimode fibre (MMF)).

Additional reference is made to FIGS. 4B-4E. The measured transmission spectra of MXene thin-film response to input powers vary from 6% to 80%, as shown in FIG. 4B. As shown in FIG. 4C, the calculated linear optical transmittance of the Ti₃C₂Tₓ films on a glass substrate as a function of wavelength decreases with an increase in the film thickness (top to bottom) of 50 nm, 67 nm, 72 nm, and 91 nm), which correlates well with experimental measurements. The model considers the measured refractive index and extinction coefficient for different thicknesses, with surface roughness measured by a profilometer. When the incident intensity at which the absorption coefficient is half of the linear absorption coefficient (i.e., α=α₀/2) define as the saturation intensity, which is dependent on the film thickness (FIG. 4D, top, shows a graph of the saturation intensity vs MXene thickness at the wavelength of 1550 nm). FIG. 4D (bottom) shows the measured thickness of MXene with profilometer (average marked by the straight black line) of spray-coated MXene on glass, compared to the modelled random roughness of MXene thin film on BK-7 substrate of the depth of 12.7 nm. It was noted that the random roughness of spin-coated films does not affect the observed nonlinear transmission effect.

The modulation depth, as schematically depicted in FIG. 4E can be determined by the maximum change in saturable absorber for a given wavelength as follows:

$$Δ {T}_{NL} ( λ ) = \frac{{T}_{NL} ( λ ) - {T}_{L} ( λ )}{{T}_{L} ( λ )} ,$$

where T_{NL} and T_{L} are nonlinear and linear transmissions, respectively. FIG. 4E shows the nonlinear transmission of the 50 nm MXene film as a function of input intensity evaluated from the transmission waveguide spectroscopy at the wavelength of 1550 nm.

### Example Experimental Operation of the Nonlinear Activation Function

A set of transmission spectrum measurements was experimentally achieved for each nonlinear activation function mechanism. The transmission spectrum was monitored on an optical spectrum analyzer to observe the nonlinear responses by controlling the input optical power. Each set includes or consists of several measurements for various input powers from 6% to 96%. Proceeding further, transfer functions were obtained that represent the instantaneous input and output power amplitudes measured at a specific wavelength.

The optical responses of the nonlinear activation function shape can be selected through tuning (also: adapting) of one or more characteristics of the optical (input) signal. Such optical signal (e.g., laser) characteristics can include, for example, wavelength, lasing mode, polarization, and/or phase. These transfer functions represent the device's nonlinear optical responses by output power vs input power relation. It was noted that these observed nonlinear functions represent a subset of functions achievable by the employed devices without modifying the structure of the devices.

A generic activation function squashes a real input number to a fixed interval specified with unitless scale (Supplementary FIG. S4). In contrast, realistic optical activation function input and output units are in the context of spectral quantities specified with units of mW/nm. Thus, in this hardware-software co-investigation, they are regarded as the relation of power in and power out. In the all-optical implementation, it is the aim to validate the performance of well-known DNN architectures by focusing on the nonlinear operation shape formed by the studied photonics devices by examining their functionality in a conventional machine learning task without considering the noise on both system and device level. More precisely the amplitude and phase noise induced by the non-linear activation functions device, as well as noise in the input signal and weights.

Example Experiment of all-Optical Neural Network Emulation

The obtained nonlinear optical responses were employed in the following conventional machine-learning task: a handwritten digit image to be classified.

Additional reference is made to FIGS. 5A-5B. FIG. 5A (top) schematically shows an emulated three-layer structure 13002, 13004 and 13006 of a fully connected network 13000. Each layer 13002, 13004 and 13006 of the emulated DNN 13000 is composed of optical interference and nonlinearity units. The bottom of FIG. 5A shows several predicted labels ([9], [3], [0], [7]) that correspond to four input handwritten digit images 13100-13400. Each layer comprises 100 neurons. The output layer in the network of the experiment has only ten neurons belonging to one of ten categories, representing digits from 0 to 9.

The Experiment was aimed to identify the representing numbers for each input image using a DNN, as schematically shown in FIG. 5A.

Several outputs predicted labels correspond to four input handwritten digit images. Feeding each image to the input layer requires preprocessing each two-dimensional matrix of a handwritten digit image to a high-dimensional vector. Then, the input signals can be encoded in the amplitude of optical pulses when propagating through the photonic integrated circuit. Each layer of the DNN includes optical interference and nonlinearity units, which implement optical matrix multiplication and nonlinear operation, respectively.

As discussed earlier, the input optical signals are weighted and combined through a mesh of integrated Mach-Zehnder interferometers. However, employing an MXene metasurface overlayer on waveguide or MXene thin film configurations can achieve the nonlinear activation function. In addition, it was noted through the experiment that between two consecutive layers, on each output connection, the nonlinear activation function is applied (e.g., each neuron sums all the weighted inputs from neurons in the proceeding layer and then applies the nonlinear activation function).

By emulating the behavior of the experimentally implementing nonlinear optical operations of the studied approaches as neuron's nonlinear activation function in photonic DNN, one can effectively evaluate their functionality.

Tensorflow platform was utilized to emulate the photonic DNN's performance in terms of accuracy and loss compared to those obtained with software-based nonlinear activation functions for the MNIST dataset. In particular, the networks used in the experiments were trained with two sets of nonlinear activation functions:
A) the all-optical nonlinearity units; and
B) software-based activation function commonly used in machine-learning applications.

The all-optically implemented transform functions are obtained from experimental measurements at various operating wavelengths for MXene metasurface overlayer on waveguide and MXene thin film configurations, representing a power-in to power-out relation for various operating wavelengths as shown in FIG. 5B.

In contrast, Supplementary FIG. S4 shows the commonly used software-based nonlinear activation function we employed to compare our photonic configurations—the Rectified Linear Unit (ReLU), Softplus, Exponential linear units (ELU), and Mish. To achieve the mathematical model of the nonlinear operations used in photonic neural network emulation, an ƒ_{NL} was considered that models the transfer functions associated with each studied mechanism due to MXene-light interaction (details presented in the Methods section).

During the training and testing process, three separate datasets were considered. The training dataset was randomly broken down into two subsets, 80% and 20% (e.g., 48,000 and 12,000 images, respectively), to train and validate the model.

The testing dataset ensures the model can classify the images without acknowledging the data beforehand, based on learning about the data features. Through the validation process, the weights in the model are not updated based on the loss calculated.

FIG. 5C shows the network prediction accuracy as a function of epoch count, when the network is trained for 50 epochs, with proposed all-optical nonlinear activation functions considering MXene metasurface overlayer on waveguide and MXene thin film compared to standard software-based nonlinear activation functions. The graphs in FIG. 5C indicate that all the proposed all-optical nonlinear activation functions achieve competitive classification accuracies against the standard software-based nonlinear activation functions on the MNIST dataset.

The validation data accuracy and loss verify the training dataset (Supplementary FIG. S5). All the proposed photonic nonlinear operations considering both MXene meta-surface overlayer on waveguide and MXene thin film achieve accuracies between 97.9% to 99.1%.

To better understand the compatible performance of the proposed activation mechanisms in terms of accuracy and loss as a function of epoch with respect to the well-established and commonly used non-linear activation functions for various kinds of networks, we emulated their behavior in a convolutional

NN (CNN). The task of the NN is the same, as it is required to identify the representing numbers for each input image of the MNIST handwritten digits data set. A stochastic gradient descent optimizer is used with a learning rate of 0.01. In addition, the input data is normalized with respect to the global mean and standard deviation of the MNIST dataset (details presented in the methods section). This network operates in a different method than that of fully connected NN. The schematics of our multiclass classification network is shown in FIG. 5D. FIG. 5D depicts a diagram of the investigated convolutional neural network illustrating the unique layers and their all-optically implemented nonlinear activation function operations, according to some embodiments. The input image of a handwritten digit comprising 28×28 pixels undergoes convolutions (labeled as conv), pooling (labeled as maxpool), and all-optical activation functions operations, followed by two fully connected layers, and last, a softmax activation function. The outputs are in the range of 0 to 9. The ANN has an input 16100 which is subjected to first Convolution & a Non-Linear Activation (block 16200). The output of block 16200 undergoes first Max Pooling (block 16300). The output of block 16300 undergoes second Convolution & Non-Linear Activation (16400) the output of which, in turn, undergoes second Max Pooling (16500), followed by third Convolution & Non-Linear Activation (16600). The output of block 16600 is input to a fully connected layer (block 16700) which produces the prediction output (16800).

FIG. 5E show graphs of the accuracy and loss as a function of epoch during the training stage and validation process, for the proposed all-optical MXene-based and the software-based nonlinear activation functions, according to some embodiments.

FIG. 5F show the experimental confusion matrix of the MNIST classification for the chosen 100 images from the test data set, using the transfer function MXene metasurface overlayer and on waveguide at wavelengths of 1550 nm. The model achieved 98.9% and 97.4% recognition accuracy of the test dataset, respectively. The proposed activation mechanisms have compatible performance in terms of accuracy and loss as a function of epoch with respect to the well-established and commonly used non-linear activation functions. It is noted that embodiments of the mapping device may also be employed for other classification tasks than disclosed herein. Left side of FIG. 5F relates to MXene thin film (free space) and right side to overlayer on waveguide (evanescent effect).

Considering the availability of dozens of stoichiometric and solid-solution MXenes with a wide range of optical properties and plasmon resonances covering the wavelength from UV to IR, all-optical non-linear mapping devices may be designed employing MXenes beyond Ti₃C₂Tₓ.

### Some Conclusions with Respect to Example Experiments

Realization of an all-optical nonlinear activation function was demonstrated operating in a wide spectral range. Ti₃C₂Tₓ MXene thin films and MXene overlayers on waveguides were fabricated their optical response was compared in the cases of:
1) evanescent excitation;
2) plane wave illumination.

It was noted that the response time in the realized all-optically implemented ANNs is the speed of light in matter namely c/n where n of silicon at 1550 nm is 3.48.

It was demonstrated that the connectivity to other neurons can be implemented via the output of our device and can induce the next neuron in the network. a unit cell effect made of two MXene nanodiscs atop the silicon waveguide was numerically explored. The resulting transmission spectrum dips can be explained as localized surface plasmon excitation at wavelengths of 1020 nm and 1560 nm. In principle, the MXene flakes form stable colloidal solutions in water without additives and surfactants due to their negative surface charge. Therefore, they can be deposited from pure water solution or other polar solvents, such as alcohols. This property may pose an important advantage of MXenes over graphene, CNTs, metal nanoparticles, etc. However, as mentioned herein, in some embodiments, substances other than MXene-based substances may be employed including, for example, graphene, CNT, metal nanoparticles, and/or the like.

The stochastic process here is statistically determined through
1) the constant concentration of MXene in water, and
2) dripped position, which may be perpendicular or about perpendicular to the waveguide surface.

For large-scale photonics based DNN deployment, both mass concentration and a polar solvent can allow tuning of the randomness. Therefore, embodiments of the mapping device may enable a tailor-made nonlinearity response by controlling the extinction properties of, e.g., the MXene metasurface.

The emulator employed in the experiment showed compatible performance of the proposed activation mechanisms based on a MXene metasurface overlayer on the waveguide and a MXene thin film, in terms of accuracy and loss as a function of epoch with respect to the well-established and commonly used nonlinear activation functions in machine-learning tasks. The nonlinear response of the activation function was achieved due to the saturable absorber property of MXene.

### Methods Employed for Realizing the Example Experiment

### Mxene Thin Films Preparation:

Ti₃C₂Tₓ was synthesized by the selective etching of Ti₃AIC₂ MAX phase powder (325 mesh) with a mixture of HF (48.5-51%, Acros Organics) and HCl (36.5-38%, Fisher Chemical) acids (Anayee, M., Kurra, N., Alhabeb, M., Seredych, M., Hedhili, M. N., Emwas, A.-H., Alshareef, H. N., Anasori, B., and Gogotsi, Y. (2020) Role of acid mixtures etching on the surface chemistry and sodium ion storage in Ti 3 C 2 T x MXene. Chemical Communications, 56 (45), 6090-6093) Click or tap here to enter text. 12 mL of HCl, and 6 mL of deionised (DI) water were mixed. After that, 1 g of MAX phase powder was added to the solution and stirred for 24 h at 35° C. After etching, the reaction product was washed with DI water using the centrifuge at 3500 rpm for 2 min until pH>6. The obtained sediment was dispersed in a 0.5 M LiCl solution. The mixture was shaken for 15 min and then centrifuged at 3500 rpm for 10 min several times until the sediment was delaminated and swelled. The swelled sediment was dispersed in DI water and then centrifuged at 3500 rpm for 10 min. After that, the dark supernatant containing primarily single-layer MXene sheets was collected for spray-coating. Finally, four thin films of ˜50 nm to ˜90 nm thicknesses Ti₃C₂Tₓ were spray-coated on a borosilicate glass (BK-7) substrate with a ratio of 4.5 mg/ml DI water.

### Mxene Thin Films Characterization:

To characterize the surface roughness and thickness of the fabricated MXene films, topography measurements were performed with the Stylus profilometer, Veeco Dektak-8.

ELLIPSOMETRICSPECTROMETRY: the optical parameters of MXene, namely, the refractive index n and extinction coefficient K, were obtained via a spectroscopic ellipsometer. Spectroscopic ellipsometer measurements were performed in the wavelength range of 245-1690 nm. The samples consisted of a BK-7 glass substrate with Ti₃C₂Tₓ coating of approximate thicknesses of 50 nm, 67 nm, 72 nm, and 91 nm.

### Waveguide Fabrication:

The rib waveguides were fabricated as detailed in reference Katiyi, A., and Karabchevsky, A. (2018) Si nanostrip optical waveguide for on-chip broadband molecular overtone spectroscopy in near-infrared. ACS Sens, 3 (3), 618-623, based on a Silicon-On-Insulator (SOI) wafer with silicon Carrier, 2 μm of silica SiO₂ and 2 m of silicon. E-beam resist poly-methyl methacrylate (PMMA) 950k was used together with a line pattern mask via a conventional photolithography process. Once the PMMA resist was developed, aluminum was evaporated to serve as a hard mask with a thickness of 250 nm via an Electron Gun evaporator. Next, the chip was soaked in acetone for four hours (lift-off process) and cleaned the chip with isopropanol. Eventually, the chip was dry-etched with SF₆+Ar and O₂ to achieve straight lines and 90-degree waveguide walls. The residue of the Al hard mask was removed with a 400K developer.

### Procedure for Preparing Mxene Flakes for Waveguide Overlayer:

The concept of waveguide overlayer is schematically shown in FIG. 2a and the preparation procedure is schematically shown in FIG. 2b. As a monolayer, the MXene might be oxidized.

The assembly of a colloidal solution can prevent the oxidization arising from the environment. In addition, no significant changes in the nonlinearity of the optical response are expected in the presence of a protective cladding, considering the Ti3C2Tx surface terminations such as —O, —OH, and —F. It is worth mentioning that several nanometers of transparent dialectic protective cladding will not affect the performance of the device.

The Ti₃AIC₂ powders were synthesized by mixing titanium carbide (Alfa Aesar, 99.5% 2 microns), aluminum (Alfa Aesar, 99.5%, 325 mesh), and titanium (Alfa Aesar, 99.5%, 325 mesh), powders in a molar ratio of 2:1.1:1, respectively (block 2510). The powders were mixed in a horizontal rotary mixer at 100 rpm for 24 h and then heated under Ar flow at 1400° C. for 3 h. The heating and cooling rates were set at 5° C./min. The resulting loosely sintered block was ball milled to powders and passed through a 400 mesh (<38 m) sieve.

The Ti₃AIC₂ powder was etched in a LiF and HCl solution (block 2520). Initially, 1 g of LiF (Alfa Aesar, 99.5%, 325 mesh) was dissolved in 10 mL of 12 M HCl (Fisher Scientific). Later, 1 g of the Ti₃AIC₂ powder was slowly added to the solution and stirred for 24 h at 35° C. and 300 rpm.

After etching the slurry was transferred into a 50 ml centrifuge tube and deionised (DI) water was added to fill the remaining volume (block 2530). It was then centrifuged at 2300 rcf for 2 min and the resulting clear supernatant was discarded (block 2540). The same washing process was repeated several times until the pH of the solution was ˜7, at which point DI water was added to the resulting Ti₃C₂Tₓ “clay” and the mixture was sonicated under bubbling Ar flow for 1 h (block 2550). To avoid oxidation, the bath temperature was kept below 20° C. using ice. The solution was then centrifuged for 1 h at 4700 rcf and the supernatant was pipetted off, dried in a drying oven at 120° C. for 12 h and sealed under Ar for storage and future use (block 2560). To obtain the MXene flakes solution, 0.1 g of dry Ti₃C₂Tₓ was added to 10 ml DI water and sonicated in an ultrasonic bath for 5 min, resulting in a solution of dispersed Ti₃C₂Tₓ suspension with a concentration of 0.01 g/ml (block 2570).

### Scanning Electron Microscopy:

The surfaces SEM micrographs of blank reference waveguides and metasurface overlayer of MXene on a rib waveguide were examined with a high-resolution scanning electron microscope (FEI Verios 460L).

### Numerical Simulation:

The absorption and extinction cross-section profiles of the nanodisks atop the waveguide were computed numerically. The three-dimensional simulation was carried out using a commercial COMSOL Multiphysics 5.6 software based on the finite element analysis method in wave optics module, as a unit cell with periodic boundary conditions. Mesh was explored to ensure the accuracy of the calculated results. The dielectric constant of the material entirely defines the material optical properties. Therefore, the empirical dielectric functions of the silicon and silica were taken from the Refractive-Index database (https://refractive index.info). In contrast, the dielectric function of MXene (Supplementary FIG. S4) obtaining via the measured refractive index distribution with a spectroscopic ellipsometer. In the simulation, the thickness of the MXene nanodisks was set to 10 nm with a radius of 0.25 μm as evaluated from SEM images of the fabricated MXene flakes.

### Experimental Systems for Nonlinear Transmission Measurements:

Two experimental systems were used to measure the nonlinearity in the optical response of the two MXene configurations. Both setups are used for achieving a broadband spectrum of the transmitted light through the proposed configurations using standard optical communication components. All setups were constructed in a cleanroom environment. The energy source for optical computing was generated using a supercontinuum white-light laser source (SuperK EXTREME EXW-12, NKT Photonics), bandwidth from 390 nm to 2400 nm, fibre delivered and collimated with an output power of 5.5 W. The beam was focused on single-mode fibre (P1-1550A-FC, 1460-1620 nm, Ø125 μm cladding, Thorlabs) using an ×10 infinity-corrected imaging microscope objective (RMS10X, with a numerical aperture of NA=0.25, Olympus).

For silicon WG covered with MXene flakes configuration, inline measurements setup was used with butt-coupled light from a single-mode fibre to the input waveguide facet. The output optical spectra were collected via the conventional silica multimode fibre (MMF 50:125 μm core to cladding respectively) directly into the optical spectrum analyzer (AQ6370D, Yokogawa), as shown in FIG. 3a. The fibers were held with 3-axis piezoelectric stages that allow flexibility for precise adjustment of the fibres to the waveguide input and output facets. In addition, the waveguide was imaged (top view) onto the camera (Axiocam, ZEISS) using a microscope (Stemi SV 6, ZEISS) for accurate inspection, characterization and alignment. Prior to the measurements, the MXene flakes solution was prepared with a ratio of 1 mg/100 ml DI water. Then, a droplet of 2 μl of the solution was dripped atop the nanophotonic rib waveguide using a micropipette and dried up in the cleanroom environment.

MXene thin film characterization was performed using the transmission setup shown in FIG. 4A. The coherent supercontinuum generation light with constant pump power at the set level was collimated via a protected silver reflective collimator (RC04FC-P01, 450 nm-20 μm, Ø4 mm beam, Thorlabs), then passed through an iris. The sample was mounted on a fixed stage and illuminated by the unpolarised supercontinuum generation white light, with a spot size of 100 μm onto the MXene nano-film on a BK-7 glass substrate. The transmitted light was collected into the optical spectrum analyzer via MMF using an ×4 infinity-corrected imaging microscope objective (RMS4X, with a numerical aperture of NA=0.1, Olympus). The laser was operated in modulated power mode that generated picosecond pulses with a repetition rate of 78.56 MHz.

### Spectrometry Measurements:

To observe the optical responses due to MXene-light interaction, the intensity of the transmitted light when the MXene is present was first measured. As a reference measurement, the spectra without the contribution of MXene were collected. The differential transmission spectra were then plotted (FIG. 3b and FIG. 4b), which are given by:

$$Δ T ( λ ) = \frac{{\vert {T}_{MXene} ( λ ) \vert}^{2}}{{\vert {T}_{Ref} ( λ ) \vert}^{2}} \qquad ( 1 )$$

In the case of MXene flakes overlayer on a waveguide, |T_{MXene}|² is the transmittance when an unpolarised light is coupled to a rib waveguide with a presence of Ti₃C₂Tₓ on the top surface, whereas |T_{Ref}|² is the transmittance spectra collected from a blank reference waveguide. In the case of MXene thin films |T_{MXene}|² is the transmittance when the unpolarised light hits the BK-7 substrate, which is covered with Ti₃C₂Tₓ nano-film, whereas |T_{Ref}|² is the transmittance through the glass medium. In each case, ten measurements were carried out to follow the changes in input power.

### Activation Function Settings:

To obtain a mathematical function that modelled the transfer function of the all-optical activation function to be used in photonic neural network emulation, we fit data points from the experimental results to the total broadband optical transmittance of the devices.

For the MXene-waveguide configuration, fit quadratic curves were fitted due to the nonlinear operation acting on the optical intensity, which is directly related to the electric field amplitude with squaring proportionality. The total transmittance is defined fundamentally by the power losses within the interaction length of the MXene-waveguide. Therefore, the transmittance through the MXene flakes overlayer on a waveguide system is obtained as in (47. Karabchevsky, A., Wilkinson, J. S., and Zervas, M. N. (2015) Transmittance and surface intensity in 3d composite plasmonic waveguides. Opt Express, 23 (11), 14407-14423):

$$T ( λ ) = {\vert {\sum }_{γ 1 = i , j , m} {C}_{γ 1} exp ( - i {α}_{γ 1} L ) \vert}^{2} \qquad ( 2 )$$

where C_{γ1}=(I_{γ0,γ1}+I_{γ1,γ0})/(4I_{γ0,γ0}I_{γ1,γ1}), L is the interaction length, α_{γ1} is an attenuation coefficient of modes in a region covered with MXene flakes, γ1 are the guided modes influenced by the MXene, and γ0 are the guided modes in a pure dielectric waveguide.

For the MXene thin film configuration, the saturable absorption property of MXene was utilized. A saturable absorber material may be characterized by the dependence of its absorption on the incident laser intensity. Therefore, at a given wavelength λ, the transmission through the MXene thin film can be expressed as follows (Yamashita, S. (2019) Nonlinear optics in carbon nanotube, graphene, and related 2D materials. Apl Photonics, 4 (3), 34301):

$$T ( I ) = 1 - Δ {T}_{NL} exp ( \frac{- I}{{I}_{S}} ) - {T}_{ns} \qquad ( 3 )$$

where ΔT_{NL} is the modulation depth, I and I_{S} are the incident and saturation intensities, and Tₙₛ is the initial transmittance of the absorber defined fundamentally by the non-saturable loss in the material and depends on the design of the saturable absorber.

### Photonic Neural Network Emulation:

The photonic DNN was modelled with an end-to-end open-source platform for machine learning TensorFlow, for handwritten digit classification tasks. The MNIST handwritten digit dataset consists of 60,000 and 10,000 images belonging to training and testing, respectively. Each image is composed of 28×28 pixel resolution associated with one of ten categories representing numbers in the range of 0 to 9. The training set was split into two subsets of 80% (training set) and 20% (validation set) images for trained and validated the model.

While the weights are subsequently optimized in the training process using the backpropagation algorithm, the validation set was used to validate the network without weights updating.

The photonic DNN is trained by feeding data into the input layer, then based on the loss calculated from output prediction (so-called forward propagation), optimizing weights using a backpropagation algorithm using a stochastic gradient descent method. The network model used a stochastic gradient descent optimizer with a learning rate of 0.001.

After forming two network architectures, their performance was evaluated using typical nonlinear activation functions. Proceeding further, the photonic NN was emulated considering our nonlinear operation based on their transfer functions.

By emulating these proposed all-optical nonlinear operations, one can estimate the effect of the all-optical nonlinear activation function on the overall functionality of the NN. The transfer functions represent the device's nonlinear optical responses by output power to input power relationships. In general, software-based nonlinear activation functions are unitless that define a nonlinear output to input relation. Therefore, the obtained transfer functions were considered as power out to power in relation, where the actual values in the context of spectral quantities are specified with units of mW/nm (or dBm/nm).

Finally, the prediction accuracy and loss of the networks employing our all-optical nonlinear activation functions were compared to those achieved with the commonly used software-based activation functions (as shown in FIG. 5, Supplementary FIGS. S5 and S6). These results conclude that the proposed all-optical nonlinear operations provide comparative performance as those successfully adopted in the machine learning community.

### Additional Information

FIG. S1A-B schematically illustrate the dispersion of MXene thin films. FIG. S1A shows a graph of the complex permittivity \tilde{ε}(λ), with real ε₁.

FIG. S1B schematically shows imaginary ε₂ parts as a function of the wavelength for different film thicknesses, as follows: 50 nm (solid purple curve), 67 nm (yellow dash-dotted curve), 72 nm (orange dashed curve), and 91 nm (blue dotted curve).

FIG. S2A-B schematically illustrates nanodisks arrangement. FIG. S2A schematically shows a unit cell including two nanodisks embedded in water (light blue medium) located on top of silicon (grey medium) surface as simulated in the numerical model. Considering the light propagating along with the waveguide core (z-direction), with evanescent field components in the y-direction extending into the sample medium.

FIG. S2B schematically illustrates the MXene nanodiscs (red) separated by 15 nm along with Perfectly matched layers (PML).

FIG. S3A-B pertain to the embodiment of MXene on a substrate. FIG. SA illustrates graphs of computed results of extinction cross-section spectra of MXene nanodiscs atop the waveguide for different input powers.

FIG. S3B schematically illustrates normalized power loss density in a slice through the MXene nanodisks (the silicon-water interface) at lower (1020 nm) and longer (1560 nm) wavelengths resonances.

FIG. S4 schematically shows graphs of different common software-based nonlinear activation functions. Represented by input/output relation: ReLU (purple), ELU (orange), tanh (blue), and Swish (yellow).

FIGS. S5A-C show graphs relating to a fully connected network for handwritten MNIST digit classification. FIG. S5A-C provide comparisons of loss as a function of epoch count during the training (FIG. 5SA), validation processes (FIG. 5SB), and model accuracy (FIG. 5SC), with proposed all-optical nonlinear activation functions considering MXene metasurface overlayer on waveguide and MXene thin film as compared to software-based nonlinear activation functions.

FIGS. S6A-B show graphs relating to a CNN network for handwritten MNIST digit classifications. FIG. S6A provides comparisons of loss as a function of epoch count during the training.

FIG. S6B provides comparisons of loss as a function of epoch count during the validation, with proposed all-optical nonlinear activation functions considering a MXene metasurface overlayer on waveguide and a MXene thin film as compared to software-based nonlinear activation functions.

A variety of free-space and on-chip activation functions were reported. The ring resonator-based activation function was reported in “Feldmann, J., Youngblood, N., Wright, C. D., Bhaskaran, H. & Pernice, W. H. P. All-optical spiking neurosynaptic networks with self-learning capabilities. Nature 569, 208-214 (2019)”.

Activation function made of liquid crystals was reported in “P. D. Moerland, E. Fiesler, I. Saxena, Incorporation of liquid-crystal light valve nonlinearities in optical multilayer neural networks, Applied Optics 35 (1996) 5301-5307”. However, the structure is comparatively bulky and therefore may not be suitable for on-chip implementation. Resonative nature of such a device may be wavelength specific and therefore any wavelength deviation may affect the device's feasibility for practical applications.

Laser-operated activation was reported in “Hill, M., Frietman, E. E. E., de Waardt, H., Khoe, G.-D. & Dorren, H. All fiber-optic neural network using coupled SOA based ring lasers. IEEE Trans. Neural Netw. 13, 1504-1513 (2002).” However, laser operation constriction may be comparatively power consuming.

The activation function made of Mach-Zehnder interferometer integrated on a chip with ring resonator which requires electrical control was reported in: Huang, C. et al. “Giant enhancement in signal contrast using integrated all-optical nonlinear thresholder”, in 2019 Optical Fiber Communications Conference and Exhibition (OFC) 415-417 (IEEE, 2019). Although implemented on a chip, such configuration may be sensitive to wavelength deviations.

Neuromorphic electrooptic activation function operating optomechanically in free-space was reported in:
R. Mirek et al. “Neuromorphic binarized polariton networks”, Nano Lett. 21, 3715 (2021); and
A. Ryou et al., “Free-space optical neural network based on thermal atomic nonlinearity”, Optica Vol. 9, Issue 4, pp. B128-B134 (2021).

The Neuromorphic electrooptic activation function eventually converts the optical signal to electronic. However, such activation function is not fully optically operated. In addition, the operation speed of such a device is about 5 orders of magnitude lower compared to all-optical activation function, as schematically illustrated in FIG. S7 showing a comparison of computational energy efficiency and processing speed between existing electronic neuromorphic demonstrations and the proposed programmable photonic platform.

FIG. S8A is a Zoom-in to a plot of normalized transmission measurement (divided by the measured maximum transmission value) of the device silicon rib waveguide covered with MXene flakes dependence on input power signal varying from 6% to 96%.

FIG. S8B is a plot of Normalized transmission to the output at a wavelength of 1550 nm (dashed line), showing the obtained nonlinear transfer function.

FIG. S9A is zoom-in to a plot of normalized transmission measurement (divided by the measured maximum transmission value) of the MXene thin films with 50 nm thickness on BK-7 substrate dependence on input power signal varying from 6% to 96%.

FIG. S9B is a plot of normalized transmission to the output at a wavelength of 1180 nm (dashed line), showing the obtained nonlinear transfer function.

Further reference is now made to FIG. 10A. In some embodiments, a method for non-linearly activating, by a nonlinearity optical unit of a mapping device, an optical input signal that is input to a node of an artificial neural network (ANN), may include:
providing an optical signal to a non-linear optical mapping device (block 10100A).

The method may further include adapting or selecting non-linear activation function characteristics of the nonlinearity optical unit through adapting or selecting one or more characteristics of the optical input signal (block 10200A). In some examples, the adapting or selecting of one or more characteristics of the optical input signal for adapting all-optically implemented activation functions, may be performed based on a feedback received relating to a classification output of the ANN. For example, the optical characteristics may be adapted to increase accuracy and/or decrease loss during a training phase of the ANN to meet a classification criterion (e.g., accuracy above a threshold level and/or loss below a threshold level).

Additional reference is made to FIG. 10B. In some embodiments, a method for performing classification of data encoded in an input signal by an artificial neural network (ANN) in which at least one or all non-linear activation functions are implemented optically, comprises:

Inputting, to the ANN, a source signal which encodes data relating to information (block 10100B) to be classified for generating an input signal to a node of the ANN.

Inputting the input signal to an all-optically implemented activation function (block 10200B) for generating an output signal encoding output data descriptive of classification information of or about the data encoded in the source signal.

Additional reference is made to FIG. 11. In some embodiments, a Non-Linear Optical Activation Function NLOAF Control Apparatus 11000 may be employed configured to receive output provided by the ANN. Such output may contain classification information, and may thus also be referred to as “classification output”. The NLOAF Control Apparatus 11000 may be configured to analyze the classification output to determine one or more operating parameter values relating to the ANN, e.g., during the ANN training phase, such as, for example, accuracy and/or loss. The apparatus may be part of a system comprising the ANN and, optionally, a light source. For example, as schematically illustrated in FIG. 1B (top), apparatus may be part of a system 30000. In some examples, NLOAF control apparatus 11000 may include a spectrum analyzer.

In some embodiments, NLOAF Control Apparatus 11000 may include a processor 11100 and a memory 11200 configured to store data 11210 and algorithm code 11220 which, when processed by processor 11100, result in the implementation of a control engine for adapting the ANN. The NLOAF control apparatus 11000 may include an Input/Output Device 11300 configured to receive ANN-related output 1202 and to provide, based on the control engine output, an ANN-Related Feedback 1204 for controlling one or more optical characteristics of the optical input signal into the ANN. NLOAF Control Apparatus 11000 may include a communication module 11500 for communicating data of the Apparatus. NLOAF Control Apparatus 11000 may also include a power module 11600 for powering the various components of the apparatus. In some examples, NLOAF apparatus 11000 may include or controllably communicate with an apparatus configured to output a light source into an all-optical ANN. Power module 11600 may comprise an internal power supply (e.g., a rechargeable battery) and/or an interface for allowing connection to an external power supply.

The term “processor”, as used herein, may additionally or alternatively refer to a controller. Processor 11100 may be implemented by various types of processor devices and/or processor architectures including, for example, embedded processors, communication processors, graphics processing unit (GPU)-accelerated computing, soft-core processors, quantum processors, and/or general purpose processors.

Memory 11200 may be implemented by various types of memories, including transactional memory and/or long-term storage memory facilities and may function as file storage, document storage, program storage, or as a working memory. The latter may for example be in the form of a static random access memory (SRAM), dynamic random access memory (DRAM), read-only memory (ROM), cache and/or flash memory. As working memory, memory 11200 may, for example, include, e.g., temporally-based and/or non-temporally based instructions. As long-term memory, memory 11200 may for example include a volatile or non-volatile computer storage medium, a hard disk drive, a solid state drive, a magnetic storage medium, a flash memory and/or other storage facility. A hardware memory facility may for example store a fixed information set (e.g., software code) including, but not limited to, a file, program, application, source code, object code, data, and/or the like.

Input/output device 11300 may include, for example, visual presentation devices or systems such as, for example, computer screen(s), head mounted display (HMD) device(s), first person view (FPV) display device(s), device interfaces (e.g., a Universal Serial Bus interface), and/or audio output device(s) such as, for example, speaker(s) and/or earphones. Input/output device 11300 may be employed to access information generated by the system and/or to provide inputs including, for instance, control commands, operating parameters, queries and/or the like.

Communication module 11500 may be configured to enable wired and/or wireless communication between the various components and/or modules of the system and which may communicate with each other over one or more communication buses (not shown), signal lines (not shown) and/or a network infrastructure.

It will be appreciated that separate hardware components such as processors and/or memories may be allocated to each component and/or module of apparatus 11000. However, for simplicity and without be construed in a limiting manner, the description and claims may refer to a single module and/or component. For example, although processor 11100 may be implemented by several processors, the following description will refer to processor 11100 as the component that conducts all the necessary processing functions of apparatus 11000.

Functionalities of apparatus 11000 may be implemented fully or partially by a multifunction mobile communication device also known as “smartphone”, a mobile or portable device, a non-mobile or non-portable device, a digital video camera, a personal computer, a laptop computer, a tablet computer, a server (which may relate to one or more servers or storage systems and/or services associated with a business or corporate entity, including for example, a file hosting service, cloud storage service, online file storage provider, peer-to-peer file storage or hosting service and/or a cyberlocker), personal digital assistant, a workstation, a wearable device, a handheld computer, a notebook computer, a vehicular device, a non-vehicular device, a robot, a stationary device and/or a home appliances control system.

### ADDITIONAL EXAMPLES

Example 1 pertains to an optical mapping device having non-linear optical characteristics. The device may comprise an optical unit that is configured to direct an optical signal from an input interface to an output interface of the optical unit. The optical unit may comprise a substance causing the optical unit to have saturable absorber characteristics such that absorption of an optical input signal guided from the input interface to the output interface by the optical unit decreases with an increase in optical signal intensity received by the optical unit. In some examples, the saturable absorber characteristics of the optical unit are adaptable.

Example 2 includes the subject matter of Example 1 and, optionally, wherein the saturable absorber characteristics are adaptable on-the-fly while the optical unit is in use.

Example 3 includes the subject matter of any one or more of the examples 1-3 and, optionally, wherein the saturable absorber characteristics are adaptable by adapting or selecting one or more characteristics of the optical input signal.

Example 4 includes the subject matter of Example 3 and, optionally, wherein the optical signal characteristics include one of the following: wavelength, lasing mode, polarization, phase or any combination of the aforesaid.

Example 5 includes the subject matter of any one or more of the examples 1 to 4 and, optionally, wherein the optical unit comprises a substance having saturable absorber characteristics.

Example 6 includes the subject matter of example 5 and, optionally, wherein the optical unit includes a waveguide covered with the substance.

Example 7 includes the subject matter of Example 6 and, optionally, wherein the waveguide includes a rib waveguide, a strip waveguide and/or a diffused waveguide.

Example 8 includes the subject matter of any one or more of the examples 1-7, and optionally, wherein the optical unit is implemented by a substrate covered with a thin film substance, e.g., arranged perpendicular to the propagation direction of the optical signal.

Example 9 includes the subject matter of any one or more of the examples 1 to 8, and optionally, wherein the saturable absorber characteristics of the substance relate to optical and/or plasmon-related characteristics.

Example 10 includes the subject matter of any one or more of the examples 1 to 9, and optionally wherein the substance includes or consists of MXene.

Example 11 includes the subject matter of any one or more of the Examples 1 to 10, and, optionally wherein the substance includes a suspension containing MXene flakes dispersed in a medium.

Example 12 includes the subject matter of example 11 and, optionally, wherein MXene concentration in the fluid covering the waveguide or the substrate is adaptable, e.g., during use of the optical unit.

Example 13 includes the subject matter of any one or more of the examples 11 to 12, optionally configured such that MXene concentration in the fluid is adaptable while an optical signal is propagating from the input to the output of the optical unit. In some examples, a fluid is provided with increased or decreased MXene concentration (or other substance concentration) for adapting the non-linear activation characteristics.

Example 14 includes the subject matter of any one or more of the Examples 1 to 13 and, optionally, wherein the wavelength of the optical signal ranges from the IR to the UV spectrum.

Example 15 includes the subject matter of any one or more of the Examples 1 to 14 and, optionally, wherein the mapping device is operable to provide non-linear activation mapping functionality at temperature ranging from about 10 degrees Celsius to about 30 degrees Celsius, at an optical input power ranging from about 1 pw to about 1000 mW.

Example 16 includes the subject matter of any one or more of the preceding examples and, optionally, wherein the optical unit is operable to implement, due to its non-linear absorption characteristics, a Non-Linear Activation Function (NLAF) of a neuron of an Artificial Neural Network (ANN).

Example 17 includes the subject matter of Example 16 and, optionally, wherein the ANN is a convolutional NN (CNN), a feedforward neural network, and/or a recurrent neural network.

Example 18 includes a system for implementing an artificial neural network, the system comprising:
an array of input waveguides configured to receive a first array of optical signals;
at least one optical mapping device according to any one or more of the preceding examples;
an optical interference unit that is in optical communication with the array of input waveguides and the at least one optical mapping device,
wherein the optical interference unit is operable to perform a linear transformation on the first array of optical signals resulting in a second optical signal representing the linear transformation result and that is input to the at least one optical mapping device to apply a non-linear activation function on the second optical signal to obtain a third optical signal representing non-linear mapping between the second and the third optical signal.

Example 19 includes an optical mapping device having non-linear optical characteristics, the device comprising:
an optical unit that is configured to direct an optical input signal from an input interface to an output interface of the optical unit; and
a substance included in and/or overlaying the optical unit such that a non-linear activation function is applied on the optical input signal.

Example 20 includes the subject matter of example 19 and, optionally, wherein the substance has saturable absorber characteristics.

Example 21 includes the subject matter of examples 19 and/or 20 and, optionally, wherein characteristics of the non-linear activation function are adaptable while the optical input signal propagates through the optical input from the input interface to the output interface.

Example 22 includes the subject matter of example 21 and, optionally, wherein the saturable absorber characteristics of the substance are adaptable through adapting of or selecting one or more characteristics of the optical signal, e.g., during training or operation of an ANN.

Example 23 includes the subject matter of example 22 and, optionally, wherein the at least one characteristic includes one of the following: wavelength, lasing mode, polarization, phase or any combination of the aforesaid.

Example 24 includes the subject matter of any one or more of the examples 19 to 23 and, optionally, including a waveguide covered with the substance.

Example 25 The optical mapping device of example 24, and, optionally, wherein the waveguide includes a rib waveguide, a strip waveguide and/or a diffused waveguide.

Example 26 includes the subject matter of any one or more of the examples 19 to 25 and, optionally, comprising a substrate covered with a thin film substance, optionally arranged about perpendicular to the propagation direction of the optical signal.

Example 27 includes the subject matter of any one or more of the examples 19 to 26 and, optionally, wherein the substance includes or consists of MXene.

Example 28 includes the subject matter of any one or more of the examples 19 to 26 and, optionally, wherein the substance includes a suspension containing MXene flakes dispersed in a medium.

Example 29 includes the subject matter of any one or more of the examples 19 to 28 and, optionally, wherein the wavelength of the optical input signal ranges from the IR to the UV spectrum.

Example 30 includes the subject matter of any one or more of the examples 19 to 29 and, optionally, wherein the optical unit is operable to provide non-linear activation mapping functionality at temperature ranging from 10-30 degrees Celsius at an optical input power ranging from 1 μW to 1000 mW.

Example 31 includes the subject matter of any one or more of the examples 19-30 and, optionally, wherein the optical unit is operable to implement, due to its non-linear absorption characteristics, a Non-Linear Activation Function (NLAF) of a neuron of an Artificial Neural Network (ANN).

Example 32 includes a system for implementing an artificial neural network, the system comprising:
an array of input waveguides configured to receive a first array of optical signals;
at least one optical mapping device according to any one or more of the preceding examples;
an optical interference unit that is in optical communication with the array of input waveguides and the at least one optical mapping device,
wherein the optical interference unit is operable to perform a linear transformation on the first array of optical signals resulting in a second optical signal representing the linear transformation result and that is input to the at least one optical mapping device to apply a non-linear activation function on the second optical signal to obtain a third optical signal representing non-linear mapping between the second and the third optical signal.

Example 33 includes a method for non-linearly activating, by a nonlinearity optical unit, an optical input signal that is input to a node of an artificial neural network (ANN), the method comprising:
adapting or selecting non-linear activation function characteristics of the nonlinearity optical unit including an optical element including and/or being overlayed with a substance having properties causing the optical unit to exhibit saturable absorber characteristics; and
wherein the selecting is performed through adapting or selecting one or more characteristics of the optical input signal.

Example 34 includes the subject matter of example 33 and, optionally, wherein the one or more characteristics of an optical input signal include wavelength, lasing mode, polarization, phase or any combination of the aforesaid.

Example 35 includes the subject matter of examples 33 and/or 34 and, optionally, further comprising: directing an optical input signal from an input interface to an output interface of the nonlinearity optical unit with the selected activation function characteristics.

Example 36 includes the subject matter any one or more of the examples 33 to 35 and, optionally, wherein the substance includes or consists of one of the following substances: MXene, graphene, CNT, metal nanoparticles, or any combination of the aforesaid.

Example 37 pertains to a method for classifying source data, the method comprising: inputting, to an artificial neural network (ANN), a source signal which encodes data relating to information to be classified for generating an input signal; and

inputting the input signal to an all-optically implemented activation function of the ANN for generating an output signal encoding data descriptive of classification information about the data encoded in the source signal.

It is important to note that the methods described herein and illustrated in the accompanying diagrams shall not be construed in a limiting manner. For example, methods described herein may include additional or even fewer processes or operations in comparison to what is described herein and/or illustrated in the diagrams. In addition, method steps are not necessarily limited to the chronological order as illustrated and described herein.

Any digital computer system, unit, device, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may directly loadable into an internal memory of a digital computer, comprising software code portions for performing the methods and/or processes as disclosed herein.

The methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The term “engine” may comprise one or more computer modules, wherein a module may be a self-contained hardware and/or software component that interfaces with a larger system. A module may comprise a machine or machines executable instructions. A module may be embodied by a circuit or a controller programmed to cause the system to implement the method, process and/or operation as disclosed herein. For example, a module may be implemented as a hardware circuit comprising, e.g., custom VLSI circuits or gate arrays, an Application-specific integrated circuit (ASIC), off-the-shelf semiconductors such as logic chips, transistors, and/or other discrete components. A module may also be implemented in programmable hardware devices such as field programmable gate arrays, programmable array logic, programmable logic devices and/or the like.

The term “random” also encompasses the meaning of the term “substantially randomly” or “pseudo-randomly”.

The expression “real-time” as used herein generally refers to the updating of information based on received data, at essentially the same rate as the data is received, for instance, without user-noticeable judder, latency or lag.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Unless otherwise specified, the terms “substantially”, “‘about” and/or “close” with respect to a magnitude or a numerical value may imply to be within an inclusive range of −10% to +10% of the respective magnitude or value.

It is important to note that the method may include is not limited to those diagrams or to the corresponding descriptions. For example, the method may include additional or even fewer processes or operations in comparison to what is described in the figures. In addition, embodiments of the method are not necessarily limited to the chronological order as illustrated and described herein.

Discussions herein utilizing terms such as, for example, “processing”, “computing”, “calculating”, “determining”, “establishing”, “analyzing”, “checking”, “estimating”, “deriving”, “selecting”, “inferring” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes. The term determining may, where applicable, also refer to “heuristically determining”.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not be construed as excluding an embodiment referring to a condition “equal or below a threshold”. It is clear that should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

It should be understood that where the claims or specification refer to “a” or “an” element and/or feature, such reference is not to be construed as there being only one of that element. Hence, reference to “an element” or “at least one element” for instance may also encompass “one or more elements”.

Terms used in the singular shall also include the plural, except where expressly otherwise stated or where the context otherwise requires.

In the description and claims of the present application, each of the verbs, “comprise” “include” and “have”, and conjugates thereof, are used to indicate that the data portion or data portions of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made. Further, the use of the expression “and/or” may be used interchangeably with the expressions “at least one of the following”, “any one of the following” or “one or more of the following”, followed by a listing of the various options.

As used herein, the phrase “A, B, C, or any combination of the aforesaid” should be interpreted as meaning all of the following: (i) A or B or C or any combination of A, B, and C, (ii) at least one of A, B, and C; (iii) A, and/or B and/or C, and (iv) A, B and/or C. Where appropriate, the phrase A, B and/or C can be interpreted as meaning A, B or C. The phrase A, B or C should be interpreted as meaning “selected from the group consisting of A, B and C”. This concept is illustrated for three elements (i.e., A, B, C), but extends to fewer and greater numbers of elements (e.g., A, B, C, D, etc.).

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable sub-combination or as suitable in any other described embodiment, example or option of the invention. Certain features described in the context of various embodiments, examples and/or optional implementation are not to be considered essential features of those embodiments, unless the embodiment, example and/or optional implementation is inoperative without those elements.

It is noted that the terms “in some embodiments”, “according to some embodiments”, “for example”, “e.g.”, “for instance” and “optionally” may herein be used interchangeably.

The number of elements shown in the Figures should by no means be construed as limiting and is for illustrative purposes only.

“Real-time” as used herein generally refers to the updating of information at essentially the same rate as the data is received. More specifically, in the context of the present invention “real-time” is intended to mean that the image data is acquired, processed, and transmitted from a sensor at a high enough data rate and at a low enough time delay that when the data is displayed, data portions presented and/or displayed in the visualization move smoothly without user-noticeable judder, latency or lag.

It is noted that the terms “operable to” can encompass the meaning of the term “modified or configured to”. In other words, a machine “operable to” perform a task can in some embodiments, embrace a mere capability (e.g., “modified”) to perform the function and, in some other embodiments, a machine that is actually made (e.g., “configured”) to perform the function.

Throughout this application, various embodiments may be presented in and/or relate to a range format. It should be understood that the description in range format is merely for convenience and brevity and should not be construed as an inflexible limitation on the scope of the embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

All references mentioned in this specification are herein incorporated in their entirety by reference into the specification, to the same extent as if each individual patent was specifically and individually indicated to be incorporated herein by reference. In addition, citation or identification of any reference in this application shall not be construed as an admission that such reference is available as prior art to the present application.

While the invention has been described with respect to a limited number of embodiments, these should not be construed as limitations on the scope of the invention, but rather as exemplifications of some of the embodiments.

1. An optical mapping device having non-linear optical characteristics, the device comprising:
an optical unit that is configured to direct an optical signal from an input interface to an output interface of the optical unit;
wherein the optical unit comprises a substance causing the optical unit to have saturable absorber characteristics such that absorption of an optical input signal guided from the input interface to the output interface by the optical unit decreases with an increase in optical signal intensity received by the optical unit; and
wherein the saturable absorber characteristics of the optical unit are adaptable.

2. The optical mapping device of claim 1, wherein the saturable absorber characteristics are adaptable on-the-fly while the optical unit is in use.

3. The optical mapping device of claim 1, wherein the saturable absorber characteristics are adaptable by adapting or selecting one or more characteristics of the optical input signal.

4. (canceled)

5. The optical mapping device of claim 1, wherein the optical unit comprises a substance having saturable absorber characteristics.

6. (canceled)

7. (canceled)

8. (canceled)

9. (canceled)

10. (canceled)

11. (canceled)

12. (canceled)

13. (canceled)

14. The optical mapping device of claim 1, wherein the wavelength of the optical signal ranges from the IR to the UV spectrum.

15. The optical mapping device of claim 1, wherein the optical unit is operable to provide non-linear activation mapping functionality at temperature ranging from about 10 degrees Celsius to about 30 degrees Celsius, at an optical input power ranging from about 1 μw to about 1000 mW.

16. The optical mapping device of claim 1, wherein the optical unit is operable to implement, due to its non-linear absorption characteristics, a Non-Linear Activation Function (NLAF) of a neuron of an Artificial Neural Network (ANN).

17. (canceled)

18. A system for implementing or including an artificial neural network (ANN), system comprising:
an array of input waveguides configured to receive a first array of optical signals;
at least one optical mapping device;
an optical interference unit that is in optical communication with the array of input waveguides and the at least one optical mapping device,
wherein the optical interference unit is operable to perform a linear transformation on the first array of optical signals resulting in a second optical signal representing the linear transformation result and that is input to the at least one optical mapping device to apply a non-linear activation function on the second optical signal to obtain a third optical signal representing non-linear mapping between the second and the third optical signal.

19. The system of claim 18, further comprising an apparatus configured to:
receive an output from the ANN;
determine whether the output meets one or more ANN operating criteria; and
based on the determining, providing a feedback for adapting one or more characteristics of the first array of optical signals.

20. An optical mapping device having non-linear optical characteristics, the device comprising:
an optical unit that is configured to direct an optical input signal from an input interface to an output interface of the optical unit; and
a substance included in and/or overlaying the optical unit such that a non-linear activation function is applied on the optical input signal.

21. The optical mapping device of claim 20, wherein the substance has saturable absorber characteristics.

22. The optical mapping device of claim 20, wherein characteristics of the non-linear activation function are adaptable while the optical input signal propagates through the optical input from the input interface to the output interface.

23. The optical mapping device of claim 22, wherein the saturable absorber characteristics of the substance are adaptable through adapting of or selecting one or more characteristics of the optical signal.

24. (canceled)

25. The optical mapping device of claim 20, including a waveguide covered with the substance.

26. (canceled)

27. The optical mapping device of claim 20, comprising a substrate covered with a thin film substance, optionally arranged about perpendicular to the propagation direction of the optical signal.

28. The optical mapping device of claim 20, wherein the substance includes or consists of MXene.

29. The optical mapping device of claim 20, wherein the substance includes a suspension containing MXene flakes dispersed in a medium.

30. The optical mapping device of claim 20, wherein the wavelength of the optical input signal ranges from the IR to the UV spectrum.

31. The optical mapping device of claim 20, wherein the optical unit is operable to provide non-linear activation mapping functionality at temperature ranging from 10-30 degrees Celsius at an optical input power ranging from 1 μW to 1000 mW.

32. The optical mapping device of claim 20, wherein the optical unit is operable to implement, due to its non-linear absorption characteristics, a Non-Linear Activation Function (NLAF) of a neuron of an Artificial Neural Network (ANN).

33. (canceled)

34. A method for non-linearly activating, by a nonlinearity optical unit, an optical input signal that is input to a node of an artificial neural network (ANN), the method comprising:
adapting or selecting non-linear activation function characteristics of the nonlinearity optical unit including an optical element including and/or being overlayed with a substance having properties causing the optical unit to exhibit saturable absorber characteristics; and
wherein the selecting is performed through adapting or selecting one or more characteristics of the optical input signal.

35. (canceled)

36. (canceled)

37. (canceled)

38. (canceled)

39. (canceled)

40. (canceled)
